(19) United States
(12) Patent Application Publication
(10) Pub. No.: US 2013/0097125 A1
(43) Pub. Date: Apr. 18, 2013

(54) AUTOMATED ANALYSIS OF UNSTRUCTURED DATA

(71) Applicants: Mazda A. MARVASTI, Coto de Caza, CA (US); Arnak V. POGHOSYAN, Yerevan (AM); Ashot N. HARUTYUNYAN, Yerevan (AM); Naira M. GRIGORYAN, Yerevan (AM)

(72) Inventors: Mazda A. MARVASTI, Coto de Caza, CA (US); Arnak V. POGHOSYAN, Yerevan (AM); Ashot N. HARUTYUNYAN, Yerevan (AM); Naira M. GRIGORYAN, Yerevan (AM)

(73) Assignee: VMWARE, INC., Palo Alto, CA (US)

(21) Appl. No.: 13/417,933

(22) Filed: Mar. 12, 2012

Related U.S. Application Data
(63) Continuation-in-part of application No. 13/271,554, filed on Oct. 12, 2011.

(51) Int. Cl. G06F 7/00

(52) U.S. Cl. 707/692; 707/E17.002

(57) ABSTRACT

The current application is directed to automated methods and systems for processing and analyzing unstructured data. The methods and systems of the current application identify patterns and determine characteristics of, and interrelationships between, events parsed from the unstructured data without necessarily using user-provided or expert-provided contextual knowledge. In one implementation, the unstructured data is parsed into attributed-associated events, reduced by eliminating attributes of low-information content, and coalesced into nodes that are incorporated into one or more graphs, within which patterns are identified and characteristics and interrelationships determined.

### TECHNICAL FIELD

The current application is directed to electronic data processing and, in particular, to an automated system for processing and analyzing unstructured, digitally encoded data and storing the results of the data processing and data analysis in an electronic memory and/or mass-storage devices.

### BACKGROUND

Electronic computing, data storage, and communications technologies have evolved at astonishing rates during the past 60 years. In the 1950s, ponderously slow, room-sized computer systems were available only to large corporations and governmental agencies. The room-sized computer systems featured less computational bandwidth, electronic-memory capacity, and data-transfer capabilities than a currently available smart telephone. In the 1950s, there were relatively few computers, which operated largely independently from one another and which could exchange data only through relatively low-density physical data-storage devices and media, while today computers are ubiquitous, feature enormous local data-storage capacities and easily access remote data-storage facilities with orders of magnitude greater data-storage capacities, and are densely interconnected by numerous different types of electronic communications devices and media.

The wide availability of computing devices and electronic data-storage and the ever-decreasing costs associated with computational bandwidth, electronic data transfer, and electronic data storage, as well as vast improvements in usability of computer systems facilitated by the wide availability of powerful and flexible application programs and program-development tools, have resulted in the application of electronic computing technologies to a wide range of human activities, from commerce and government to education, entertainment, and recreation. As a result, ever increasing amounts of digitally encoded and computer-generated data are being produced and electronically stored. These data vary from the output of electronic monitoring and scientific equipment, to enormous amounts of data related to e-commerce and digitally encoded entertainment content, and to vast amounts of operational data generated by various types of local and distributed computing facilities. A small portion of the data currently being produced and stored is organized by, and maintained within, electronic database management systems, which provide a range of storage, retrieval, and query-based information-extraction services. In general, electronic data is processed and formatted prior to input into database-management systems, and the processing and formatting is carried out in a logical context encoded in database schemas stored within the database-management system to facilitate the various data-storage, data-retrieval, and information-extraction operations. As one example, a large educational system may store information about students, staff, and faculty members in a large database-management system according to a database schema that defines the various different types of discrete data units that together represent students, staff, and faculty members. Student data may be input through a user-interface application that displays a student record into which data can be entered and edited and from which a digitally encoded data record can be generated for input into the database-management system. Because the data types, data relationships, and the data organization are logically encapsulated in the database scheme, a database-management system can provide a query-based interface by which users can extract many different types of information from the stored data. For example, many database management systems storing educational-system data would allow a user to extract, through a query-based interface, the number of currently enrolled female students between the ages of 21 and 23 whose families reside in a particular state. Queries can be written in a structured query language, which allows users and developers to construct complex queries that were not anticipated or imagined at the time that data was originally stored in the database management system.

A much larger portion of the digitally encoded data currently generated and stored in electronic data-storage facilities is not processed and formatted, or structured, as in the case of data stored in database-management systems. Because unstructured data does not generally have multiple levels of well-understood, logical organization and may not even be systematically encoded, unstructured data is generally not amenable to information extraction through a query-based interface, as is the case for data stored in database-management systems. One example of such unstructured data is the often voluminous output of operational data by computer systems that is generally stored in various types of log files. Log files may contain status, error, and operational information generated during computer-system operation in order to allow operation of the computer system to be analyzed, problems revealed by the analysis to be diagnosed, and various classes of data corruptions and losses to be ameliorated. Log entries are often encoded according to log-entry templates and stored as a continuous stream of characters or series of entries. There are generally no query-based interfaces for extracting information from log files that would allow a diagnostician to easily analyze sequences of logged events that lead to problems. Even when stored data is structured, there may be significant amounts of useful information present within the stored data that cannot be easily identified and extracted dues to the constraints and limitations of information-extraction tools, including query-based interfaces. The rate of development and evolution of technologies for processing and extracting information from stored, digitally encoded data have not matched the rate at which digitally encoded data is being produced and stored, as a result of which enormous amounts of information residing within electronically stored, digitally encoded information is not currently accessible to potential users of that information. Researchers and developers of data-processing systems and information-extraction tools as well as a wide variety of different types of computer users, computer manufacturers, and computer vendors continue to seek new systems and methods for processing and analyzing electronically stored, digitally encoded data.

### SUMMARY

The current application is directed to automated methods and systems for processing and analyzing unstructured data. The methods and systems of the current application identify patterns and determine characteristics of, and interrelationships between, events parsed from the unstructured data without necessarily using user-provided or expert-provided contextual knowledge. In one implementation, the unstructured data is parsed into attributed-associated events, reduced by eliminating attributes of low-information content, and coalesced into nodes that are incorporated into one or more graphs, within which patterns are identified and characteristics and interrelationships determined.

### BRIEF DESCRIPTION OF THE DRAWINGS

FIG. 1 shows a representation of an unstructured-data file.

FIG. 2 illustrates transformation of a particular logical entry into an attribute-associated event.

FIG. 3 illustrates the result of a data-processing step in which unstructured data is transformed into a set of n attribute-associated events.

FIG. 4 illustrates, using the illustration conventions of FIG. 3, a representation of a set of events associated with three different classes of attributes.

FIG. 5 shows a C++-like pseudocode implementation of a function ƒ_{eq}( ) that is applied to two events to determine whether or not the events are equal.

FIG. 6 illustrates a data-reduction step carried out by certain implementations of the data-processing and data-analysis methods to which the current application is directed.

FIG. 7 shows a C++-like pseudocode implementation of the data-reduction step discussed above with reference to FIG. 6.

FIG. 8 illustrates an event-to-node coalescing operation carried out by certain of the data-analysis and data-processing methods to which the current application is directed.

FIG. 9 illustrates one implementation of the event-to-node coalescing operation discussed above with reference to FIG. 8.

FIG. 10 shows a C++ pseudocode function eventDistance computes the distance between two events.

FIGS. 11A-B illustrate distances computed by the function eventDistance for two different types of attributes.

FIG. 11C illustrates coincidence of two events.

FIG. 12 illustrates an initial, densely interconnected graph of nodes.

FIG. 13 illustrates graph-edge reduction based on computed mutual information between pairs of nodes.

FIG. 14 shows a C++-like pseudocode example initial-graph-generation routine that can be used to generate the initial list of nodes corresponding to an initial graph, such as the graph shown in FIG. 12.

FIGS. 15-19 illustrate graph-based steps carried out in certain implementations of the data-processing and data-analysis methods to which the current application is directed.

FIGS. 20-26 illustrate certain of the patterns that can be extracted from edge-reduced, directed graphs produced by the data-processing steps discussed above with reference to FIGS. 1-19.

FIG. 27 provides a control-flow diagram that generally describes the unstructured-data processing and unstructured-data analysis carried out according to various implementations and methods to which the current application is directed.

FIG. 28 illustrates construction of possible paths within an edge-reduced, directed graph such as that shown in FIG. 20.

FIGS. 29-32 provide control-flow diagrams that illustrate identification and extraction of critical and extreme paths from an edge-reduced directed graph, such as that shown in FIG. 20, by a routine “paths.”

FIG. 33 provides a control-flow diagram for a routine “classify nodes” which identifies critical nodes, black-swan nodes, and root nodes.

FIG. 34 provides a control-flow diagram for the routine “consider links,” called in step 3309 of FIG. 33.

FIGS. 35-37 show certain of the patterns extracted from edge-reduced directed graphs prepared from an unstructured-data VPX_EVENT file by an implementation of the data-processing and data-analysis methods to which the current application is directed.

FIGS. 38-41 show certain of the patterns extracted from edge-reduced directed graphs prepared from unstructured-data by application of the data-processing and data-analysis methods to which the current application is directed.

FIG. 42 provides a graph of execution time for an implementation of the data-processing and data-analysis methods to which the current application is directed versus the number of events parsed from the unstructured data.

FIG. 43 illustrates a general-purpose computer system.

### DETAILED DESCRIPTION

The current application is directed to methods and systems for automated processing and analysis of unstructured data. The phrase “unstructured data” refers to data that has not been deliberately formatted and organized according to contextual subject-matter information and knowledge regarding the data in order to facilitate extraction of information regarding patterns and interrelationships between data entities through a query-based interface or existing application program or that lacks structure and organization that would allow for query-based or existing-application-program-based information extraction or information regarding patterns and interrelationships between data entities. As one example, automatically generated computer log files that include log entries that encode various status, error, and computer-operations-related information, may be regarded as being unstructured even though the log entries included in the log file are prepared according to certain templates or formats because, although the entries may be parsed from the log file, the entries and information contained within the entries is not encoded and organized in a way that would allow a reviewer to extract information regarding patterns of, and interrelationships between, multiple log entries from the log file via a query-based interface or by simple script-based or existing-application-program-based methods. While the log file may contain a wealth of information regarding various operational patterns that lead to problems and particular operational behaviours of the computer system, that information is not practically accessible to either human analysts or automated-analysis methods due to the unstructured nature of the log files. Unstructured data is contrasted, above, with structured data, such as data stored in database management systems or produced and managed by specialized application programs.

Method and system implementations to which the current application is directed employ steps of initial parsing, data reduction, data aggregation, and generation of data relationships from which patterns and other characterizations can be extracted. The patterns and characterizations generated by method and system implementations to which the current application is directed are stored in an electronic memory, mass-storage device, or by some other physical data-storage method for subsequent retrieval and further analysis by human analysts and/or higher-level automated analysis systems.

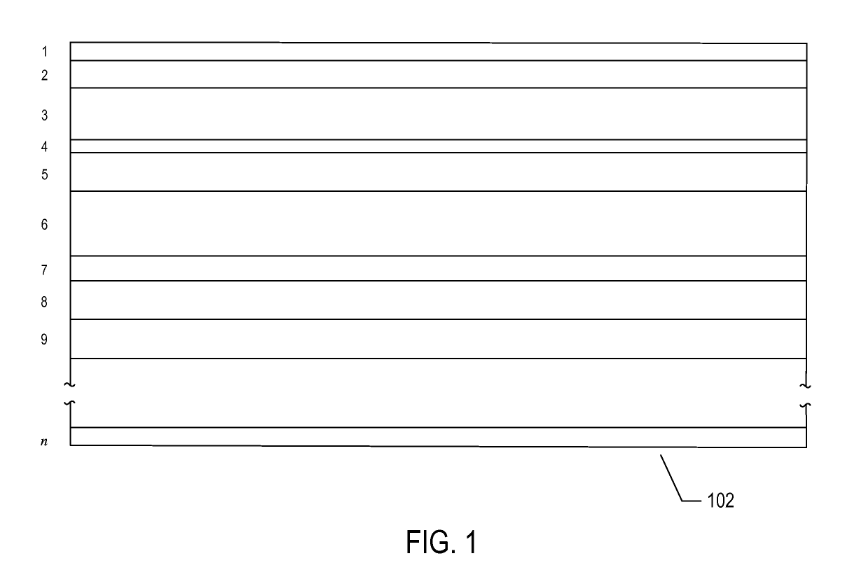

FIG. 1 shows a representation of an unstructured-data file. The file can be viewed as a very long sequence of byte-encoded or word-encoded symbols and/or numbers and other similar types of data. The symbols may have been encoded according to any of the common alphanumeric-symbol encoding standards, including the American Standard for Information Interchange (“ASCII”) standard and the more recent Unicode standard. Although the data contained in the file is unstructured, the data is generally not random, but is instead logically encoded and can be parsed or resolved into a set of n logical entries by automated methods. In FIG. 1, the file 102 is represented as a sequence of n logical entries, each of which contains a number of byte-encoded or word-encoded symbols. In some cases, the logical entries may have uniform sizes, but, in most cases, the logical entries have variable sizes and the boundaries between logical entries may be recognized, during automated processing, by patterns of symbols or according to additional meta information supplied in addition to, or within, the file. In certain cases, multiple files or other data objects may serve as a starting point for data processing and data analysis, and may be processed to generate a list of entries.

It should be noted at the onset that the unstructured data that represents the starting point for the data-processing and data-analysis methods to which the current application is directed is not abstract or intangible. Instead, the unstructured data is necessarily digitally encoded and stored in one or more physical data-storage devices, such as an electronic memory, one or more mass-storage devices, or other physical, tangible, data-storage devices and media. It should also be noted that the currently described data-processing and data-storage methods cannot be carried out manually by a human analyst, because of the complexity and large numbers of intermediate results generated during processing and analyzing of even small amounts of example unstructured data, and because the unstructured data is first read from one or more electronic data-storage devices and because the results of the data processing and data analysis are stored within one or more electronic data-storage devices. Instead, the currently described methods are necessarily carried out by electronic computing systems that access electronically stored data and that digitally encode and store analysis results in one or more tangible and physical data-storage devices.

In a next step, the entries are transformed into attribute-associated events. In a general view of entries, each entry can be described as a set of attributes. The transformation of logical entries into attribute-associated events and the initial division of the unstructured-data symbol string into logical entries may, in certain implementations, occur in a single processing step. In various implementations, the transformation of unstructured data into attribute-associated events may be rule driven, may be template driven, or may be carried out according to a programmatically implemented procedure in which logical-entry boundaries and attribute-value encodings are hard coded.

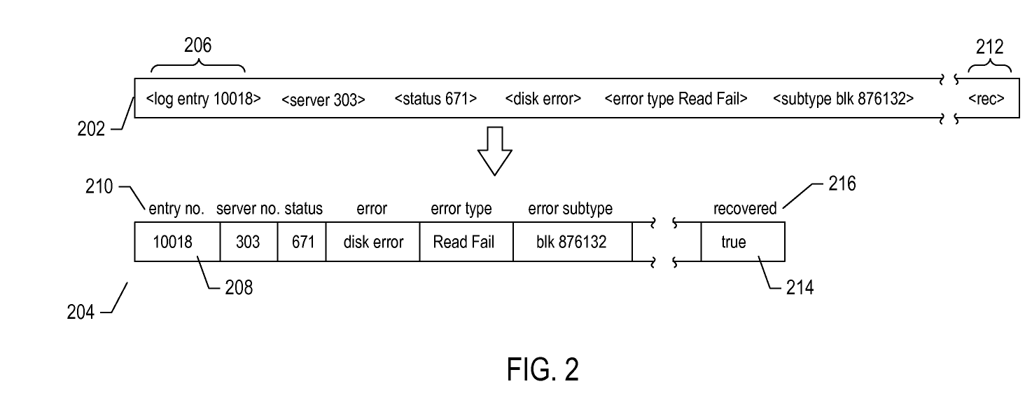

FIG. 2 illustrates transformation of a particular logical entry into an attribute-associated event. The logical entry 202 is a hypothetical symbol string representing a computer log entry used for illustration purposes. The computer log entry may have been automatically generated according to one of one or more log-entry templates or formats, and thus has a local, logical structure that can be automatically parsed to generate a set of attributes 204 that correspond to the logical entry and that together compose an event. In the example shown in FIG. 2, the logical entry includes a series of log-entry sub-entries demarcated by angle brackets. Information contained in each log-entry sub-entry, in the example shown in FIG. 2, is rendered by the transformation process illustrated in FIG. 2 into an attribute value. Thus, for example, a log-entry sub-entry 206 “<log entry 10018>” is transformed into the numeric attribute value “10018” 208 for the attribute “entry no” 210. In this example, a portion of the log-entry sub-entry, namely the text “log entry,” identifies an attribute and the remaining portion of the log-entry sub-entry, “10018,” is parsed as the attribute value corresponding to the attribute. As another example, the final log-entry sub-entry 212 includes only the symbol string “rec,” which is transformed, by parsing, into an attribute value “true” 214 for an attribute “recovered” 216. The logical entry 202 have been extracted from the unstructured-data symbol string based on symbol length, a number of angle-bracket-demarcated log-entry sub-entries, information extracted the log-entry sub-entries or from a header object, demarcation symbols that are filtered and removed during the transformation of the unstructured-data symbol string into logical entries, or on some other such information. Logical entries may have many different sizes, contents, and substructure organizations, and may correspond to a variety of different types of data objects contained within various different types of unstructured data.

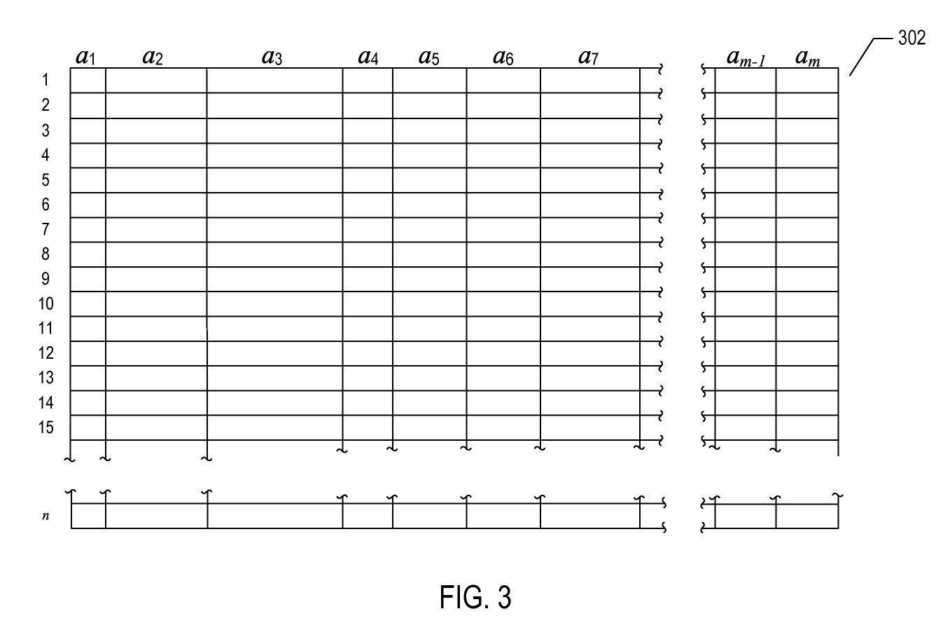

FIG. 3 illustrates the result of a data-processing step in which unstructured data is transformed into a set of n attribute-associated events. In FIG. 3, as in many of the figures in the current application, actual symbolic attribute-value data is not shown, in the interest of simplicity of illustration. Instead, the table-like representations of lists or sets of attribute-associated events show cells that each contains an attribute value, not shown in the figures, that generally comprises one or more symbols and/or numeric values. As shown in FIG. 3, initial unstructured data has been transformed into a set of n events, each represented in FIG. 3 by a row, such as the first row 302 representing a first event e₁. All of the different possible attributes with which events are associated are represented by a set of m columns each associated with logical attribute names a₁, a₂, . . . , aₘ. Any particular event may be associated with fewer than the total m attributes, in which case the cells in the row representing the entity corresponding to attributes not associated with the entity are empty or designated as being undefined. The two-dimensional representation of attribute-associated events, shown in FIG. 3, is, in the general case, sparse. However, in certain special cases, all of the events may each be associated m attributes.

In the general case, an event eᵢ can be represented as:

eᵢ={a_{i,p},a_{i,q}, . . . ,a_{i,z}}.

In this notation, each attribute value has two indices corresponding to row and column indices with respect to the representation shown in FIG. 3. In other words, the notation “a_{i,p}” indicates, in the above expression, that the event eᵢ is associated with a specific value a_{i,p} of attribute aₚ.

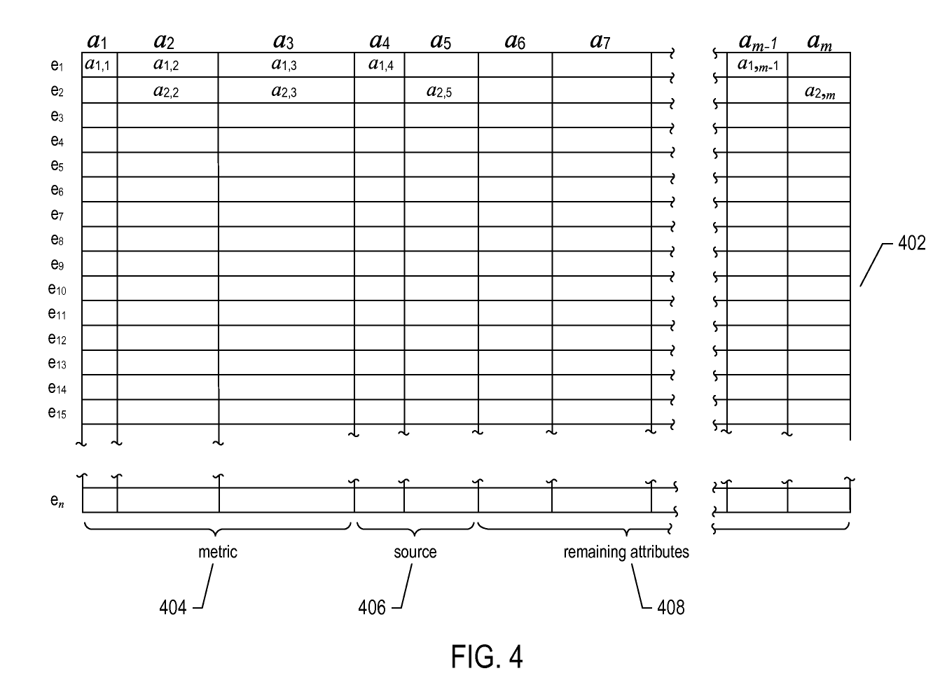

Although the data-processing and data-analysis methods to which the current application is directed may be carried out on events represented by the above-provided general notation, many implementations are directed to events that are associated with three different categories of attributes. FIG. 4 illustrates, using the illustration conventions of FIG. 3, a representation of a set of events associated with three different classes of attributes. As indicated at the bottom of the two-dimensional-array representation 402 of the set of events shown in FIG. 4, a number of attributes are collectively referred to as the “metric attributes” 404, a number of attributes are collectively referred to as the “source attributes” 406, and all remaining attributes are classified as belonging to a remaining-attributes class 408. The metric attributes 404 together comprise the value of a metric that is used to designate groups of events as being coincident. Example real-life metric attributes include a single-attribute time metric, such as an integer representing the time, in seconds, elapsed from an arbitrary initial time, a two-attribute plane-location or surface-location metric, or a three-attribute Cartesian-coordinate metric. In the case of the time metric, the events that occur close to one another along a time line may be deemed to be coincident. In the case of a two-dimensional or three-dimensional spatial-location metric, events that occur close to one another on a surface or within a three-dimensional volume may be considered to be coincident. Many other types of metric can be used in the data-processing and data-analysis methods described below. The designation of one or more attributes as together comprising the metric class of attributes may result from human analysis and human-generated input to the data-analysis and data-processing methods or may be automatically inferred from the set of events during data-analysis. In certain cases, the data analysis may be conducted iteratively using different attributes or sets of attributes as the metric class of attributes in order to discover useful metrics as part of the data-processing and data-analysis.

The one or more attributes designated as source attributes 406 identify the source of each event. For example, a machine network address or universal identifier encoded within a processor may be an attribute of each event extracted from a computer log file, identifying the particular computer system that generated the event. As another example, telephone numbers included in logs of telephone calls generated and stored within a telecommunications exchange may identify the source telephone number, or event source, for each telephone-call-log entry. All of the remaining attributes, other than the attributes designated as metric attributes and source attributes, fall into the remaining-attributes class 408, and are not further classified or characterized.

The less-general representation of events as being associated with metric, source, and remaining attributes can be described as:

eᵢ={e_{i,metric},e_{i,source},e_{i,attributes}}
where
   r, . . . , t are indices of metric attributes;
   u, . . . , w are indices of source attributes;
   x . . . , z are indices of remaining attributes;

e_{i,metric}={a_{i,r}, . . . ,a_{i,t}};

e_{i,source}={a_{i,u}, . . . ,a_{i,w}}; and

e_{i,attributes}={a_{i,p},a_{i,q},q_{i,x} . . . ,a_{i,z}}.

Although the metric attributes and source attributes were shown to be contiguous, the metric and source attributes may be subsets of one or more attributes selected from any of the m attributes with which an event may be associated. Because attributes can be logically rearranged and logically reordered, the m attributes can be ordered so that the metric attributes have the lowest indices, the source attributes the next-lowest indices, and the remaining attributes the highest indices, as in the representation shown in FIG. 4. Similarly, two attributes may be coalesced into a single attribute by joining the attribute values for each of the attributes together within each event. Therefore, the less general events associated with metric, source, and remaining-attributes can be equivalently represented as being associated with a single metric attribute m and a single source attribute s:

eᵢ≡{e_{i,m},e_{i,s},e_{i,p},e_{i,q}, . . . ,e_{i,z}}.

There are three comparison operations employed in the described data-analysis and data-processing methods. These comparison operations can be described as:

aₚ=a_{q} when f_{eq}(aₚ,a_{q})→true

aₚ≅a_{q} when fₚ(aₚ,a_{q})→true

eᵢ=eⱼ when f_{eq}(eᵢ,eⱼ)→true

Two attribute values aₚ and a_{q} are considered to be equal when the function ƒ_{eq}(aₚ,a_{q}) returns true. The function ƒ_{eq}( ) , when applied to attribute values, determines whether or not two different digital encodings represent the same logical attribute value. One implementation of the function ƒ_{eq}( ) for symbol-string attribute values would be a symbol-string comparison that returns true only when the symbol strings are identical. However, in a more general case, the function ƒ_{eq}( ) may carry out a more complicated analysis that may result in two different symbol-string encodings being recognized as, or determined to be, encodings of a single underlying attribute value. As with most such determinations used in the described implementations of the data-processing and data-analysis methods to which the current application is directed, the function ƒ_{eq}( ) may be specified by a human analyst based on various criteria or, alternatively, may be inferred by higher-level automated analysis. As one example, the two different attribute values “pink” and “pinkish” may be determined to be identical by the function ƒ_{eq}( ). This function may be attribute-specific, in many implementations, or may be general in other implementations. The function ƒₚ( ) is similar to the function ƒ_{eq}( ), but determines whether or not two attribute values are proximal rather than determining whether the two attribute values are equal. For example, in the case of a time-metric attribute value, fₚ( ) may determine that two time-metric values separated by a time difference of less than a threshold amount are proximal, or approximately equal. The criteria by which two attribute values are designated as being equal, according to function ƒ_{eq}( ) and the criteria by which two attribute values are designated as being proximal or approximately equal by the function ƒₚ ( ) may be similar, employ different threshold values, or may be entirely different, depending on the implementation. While the above examples involve using a natural-language context and knowledge about the meaning of a metric attribute, the criteria by which attributes are found to be equal, or equivalent, by the function ƒ_{eq}( ), or proximal, by the function ƒₚ( ), may be automatically inferred based on statistical and other considerations. Finally, the function ƒ_{eq}( ), when applied to events, determines whether or not two events are equal.

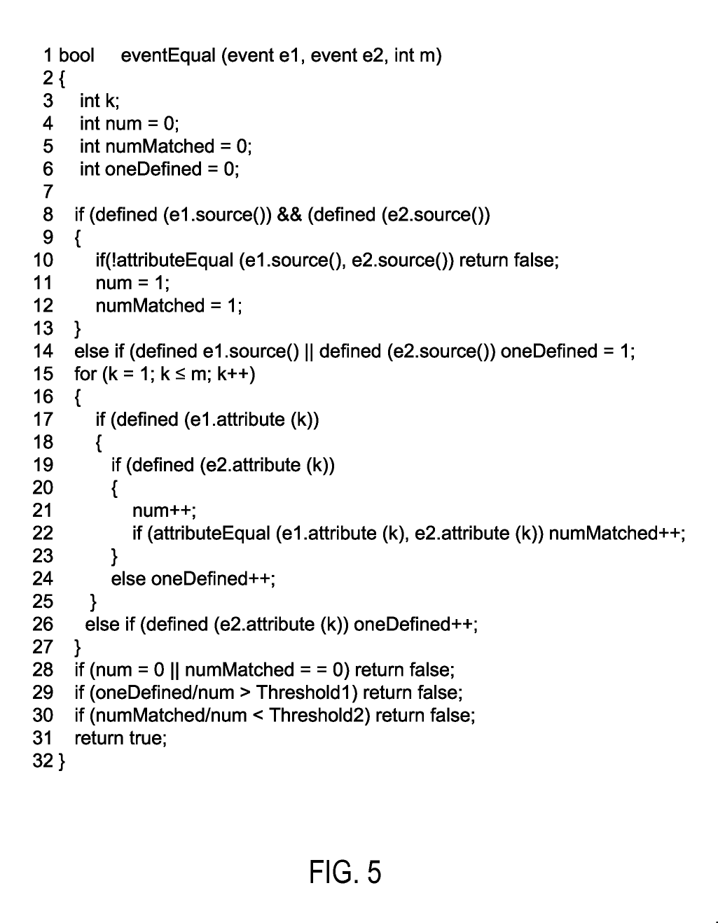

FIG. 5 shows a C++-like pseudocode implementation of a function ƒ_{eq}( ) that is applied to two events to determine whether or not the events are equal. The function eventEqual receives, as parameters, events e1 and e2 and a total number of attributes m of the remaining-attributes class that can be associated with an event. In alternative implementations, m may be a constant and may not need to be passed to the function as an argument. The function eventEqual first declares, on lines 3 through 6, the following local variables: k, an iteration variable; num, which counts the number of attributes defined for both event 1 and event 2; numMatched, which counts the number of attributes associated with events e1 and e2 that are defined for both events and have equal values; and oneDefined, which counts the number of attributes that are defined for one, but not both, of events e1 and e2. When the source attribute is defined for both events e1 and e2, as determined on line 8, but the attribute values for the source attributes of the two events are not equal, as determined on line 10, then the function eventEqual returns false. Events must have the same source to be considered to be equal. Otherwise, on lines 11 and 12, local variables num and numMatched are both set to 1. When the source attribute for only one of the two events is defined, local variable oneDefined is set to 1, on line 14. In certain alternative implementations the function eventEqual returns false unless both the source attribute for event e1 and source attribute for event e2 are defined and the attribute values for the source attributes are identical. Next, in the for-loop of lines 15-27, all of the possible attributes of the remaining-attributes class that may be associated with events e1 and e2 are considered. The number of attributes defined for both events e1 and e2 are counted in the local variable num, the number of those attributes that are both defined for both events e1 and e2 and have equal attribute values for both events are counted in the local variable numMatched, and the number of attributes that are defined for one but not both of events e1 and e2 are counted in the local variable oneDefined. Then, on lines 27-29, various tests and comparisons are made to determine whether events e1 and e2 are equal. When either of local variables num and numMatched contain the value “0,” the function eventEqual returns false on line 27. Two events cannot be equal unless at least one attribute is defined, in common, for both events and attribute values associated with the two events for that attribute are equal. When the ratio of the number of attributes that are defined for one, but not both, of events e1 and e2 divided by the number of attributes defined for both events e1 and e2 is greater than a first threshold value, then the function eventEqual returns false, on line 28. When the number of attributes defined for both events e1 and e2 that have equal values divided by the total number of attributes that are defined for both events e1 and e2 is less than a second threshold value, then the function eventEqual returns false on line 29. Otherwise, events e1 and e2 are determined to be equal by the function eventEqual on line 30. It should be noted that the metric attribute is not considered by the function eventEqual in determining whether or not two events are equal. The metric attribute is, instead, later used to determine whether or not events coincide.

In general, the function eventEqual provides the ability to classify two events as being equal even though the symbolic or numeric representations of the attribute values associated with the events differ and the number of attributes associated with the events differ. As one example, when processing and analyzing computer event logs, it may be desirable to consider all events generated by a particular computer with the primary event type “diskFailure” to be equal, even though the values of event subtypes may differ. There are many possible different implementations for the function eventEqual, depending on the type of data analysis being carried out. Furthermore, the first and second thresholds that appear on lines 29 and 30 of the above-provided implementation of the function eventEqual may be varied and optimized, during data processing and data analysis, in order to balance the complexity of the analysis due to the number of different types of events considered in the analysis with the degree to which useful and informative patterns and characteristics can be extracted from complex networks of interrelationships between types of events.

After the structured-data file or data object has been processed to generate a sequence of attribute-associated events, as discussed above with reference to FIGS. 1-4, the data-processing and data-analysis methods to which the current application is directed next carry out a data-reduction phase in which attributes that have relatively low information content are identified and disregarded from subsequent processing and analysis. It should be noted, at this point, that all of the steps of the data processing and data analysis may be carried out in different ways, depending on the particular implementation. As one example, although the unstructured data file or data object would appear, in FIGS. 1-4, to be reformatted and rewritten in the process of transforming unstructured data to attribute-associated events, reformatting and rewriting may be carried out logically, rather than by physically reformatting the data. Additional memory-resident data structures or data structures swapped between memory and mass-storage devices can be created to reference the location of events and attributes in an unstructured-data file or other data object. As another example, the sparse two-dimensional-array representation of event-associated attributes in FIGS. 3 and 4 may be logical views of densely-encoded events without indications of undefined attributes, with the particular attributes and attribute-values associated with each event indicated in a separate data structure or determined from the attribute values of formatting and layout conventions used to encode the data entries interpreted as events. Similarly, data reduction in which attributes are disregarded from further analysis does not imply that the unstructured-data file or other data object is necessarily rewritten and/or reformatted to physical eliminate attribute values corresponding to disregarded attributes. Instead, the additional data structures residing in memory swapped between memory and mass-storage devices can be altered or restructured to eliminate particular attributes from further consideration without physically removing the corresponding attribute values from the unstructured-data file, files, or other data objects. Physical reformatting and restructuring is possible, as well.

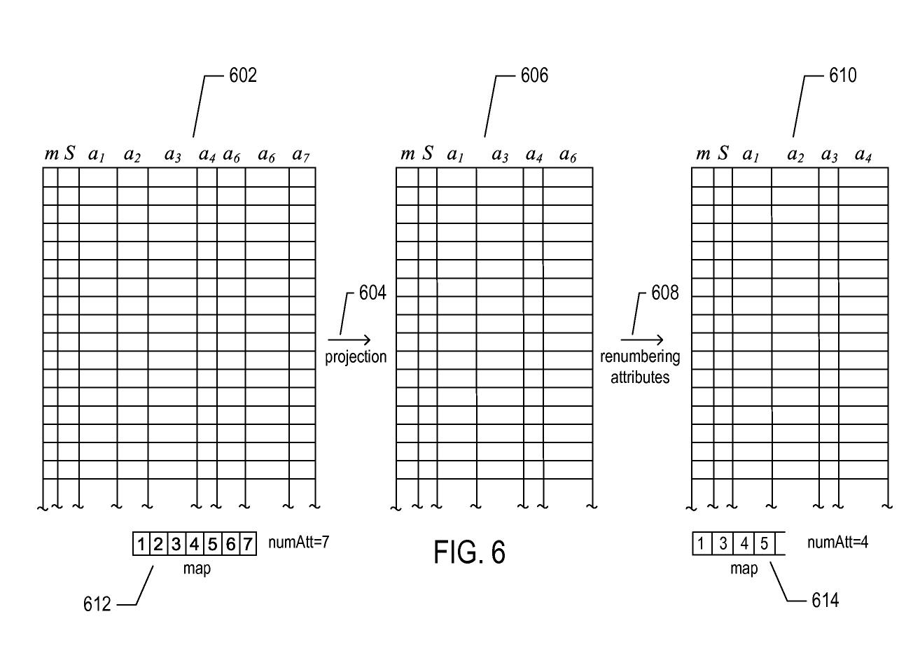

FIG. 6 illustrates a data-reduction step carried out by certain implementations of the data-processing and data-analysis methods to which the current application is directed. An initial set of events 602 obtained by the initial processing steps discussed above is analyzed to determine or estimate the information content with respect to each of the attributes a₁, a₂, . . . of the remaining-attributes class of attributes associated with the events. Attributes with relatively low information content are then eliminated in a projection step 604 to produce a list of events with fewer attributes in the remaining-attribute class 606. In an example shown in FIG. 6, attributes a₂, a₅, and a₇ are estimated to have low information content, and thus have been removed to produce the data-reduced list of events 606. The remaining attributes can then be renumbered 608 to produce a final data-reduced list of events 610. As indicated by the simple data structures 612 and 614 below the initial set of events 602 and final set of events 610 in FIG. 6, the described data reduction can be effected by changing the contents of a simple integer-array map and the number stored in a variable corresponding to the number of attributes that may be associated with a given event. Indexing the map using an attribute number from among the attributes in the data-reduced list of events 610 provides the number or order in the sequence of original attributes of that attribute. By indirection through an attribute map, low-information-containing attributes can be eliminated without physically eliminating the attribute values associated with the low-information-containing attributes from the unstructured-data files or other data objects.

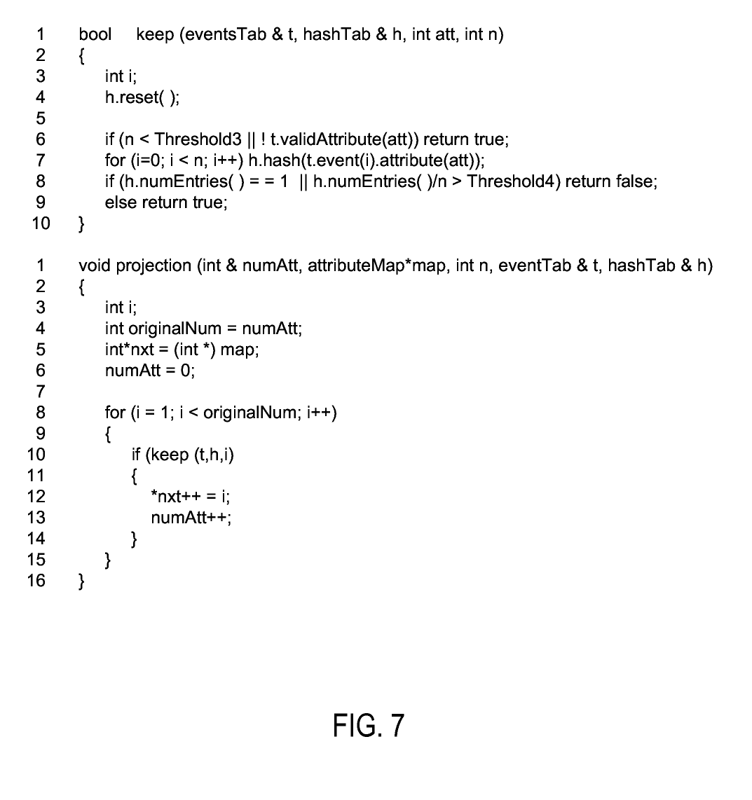

FIG. 7 shows a C++-like pseudocode implementation of the data-reduction step discussed above with reference to FIG. 6. The function keep receives, as input parameters, a table or list of events t, a hash table h, the numeric identifier of one of the original attributes of the remaining-attributes class associated with events, and the number n of events in the event table or list. When n is less than some threshold value or when the attribute at position att in the original set of attributes associated with events is not a valid attribute index, as determined on line 6, the function keep returns true, because the function keep cannot make a determination as to whether or not the attribute att is a low-information-containing attribute. The function keep then, in the for-loop on line 7, hashes every attribute value for the attribute att into the hash table h. When the number of unique entries that result from hashing the attribute values into the hash table is 1 or the number of unique hash-table entries divided by n is greater than a threshold number, the function keep returns false to indicate that the attribute is a low-information-containing attribute. Otherwise, the function keep returns the value true on line 8. The function projection considers each of the original numAtt remaining-attribute attributes and prepares a data-reduced attribute map, such as that shown below the data-reduced set of events 610 in FIG. 6, using the function keep to determine whether or not each attribute should be disregarded from subsequent data processing and data analysis. In the following discussion, it is assumed that the number m refers to the number of attributes, other than the metric and source attribute, which remain after the data-reduction step discussed above with reference to FIG. 6.

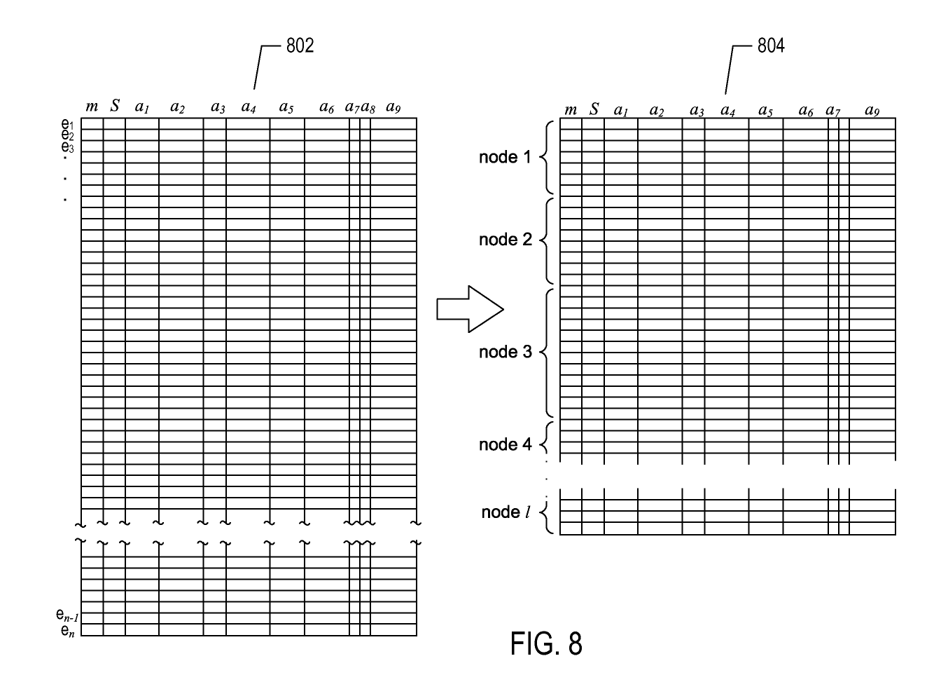

FIG. 8 illustrates an event-to-node coalescing operation carried out by certain of the data-analysis and data-processing methods to which the current application is directed. In this next step, a data-reduced set or table of events 802 is organized into a list of nodes, each node comprising one or more related events 804. In this node-generation step, groups of events that are identical, or true duplicates, may be compressed into a single corresponding event. As one example, during the data-reduction process discussed above with reference to FIG. 6, an attribute may be eliminated or disregarded, the attribute values of which represented the only difference between a number of otherwise identical events. Elimination of the attribute thus results in transforming a number of events previously distinguishable based on the attribute values for that attribute into a data-reduced set of identical events. As another example, a computer error log may contain multiple, identical error-log entries corresponding to a single error event, due to anomalies in error reporting or redundancies inherent in error-reporting code paths. Thus, the set of events 804 produced during the coalescing of events into nodes, represented in FIG. 8, is shown to be shorter than the data-reduced set of events 802. All of the events that are together classified as belonging to a single node are events that are considered to be equal by the above-described eventEqual function. The event eventEqual function does not consider the metric attribute associated with events. When the metric attribute, as one example, represents time, then a set of events deemed to be equal by the event equal function may occur at different times along an arbitrary time line. Thus, events that are coalesced together into a particular node are events that are equal or equivalent in all respects other than with respect to the value of their metric attribute.

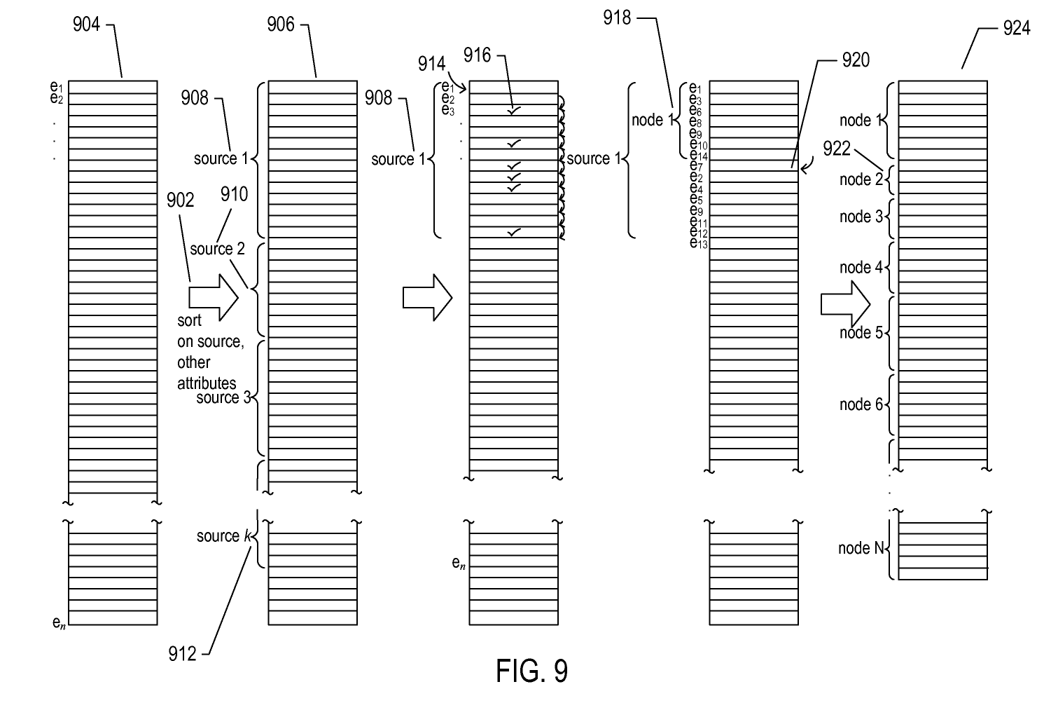

FIG. 9 illustrates one implementation of the event-to-node coalescing operation discussed above with reference to FIG. 8. In a first step 902, the data-reduced set of events 904 obtained by initial processing steps discussed above with reference to FIGS. 1-6 is sorted to produce a sorted list of events 906. The sort may be a quick-sort type of sort on the source attribute of the events on the list of events, or another sorting technique. Sorting reorganizes the list of events so that all of the events having a source attribute equal to a first source-attribute value are grouped together in a first subset of events 908, all of the events having common second source-attribute value are grouped together in a second subset of events 910, with additional subsets of events corresponding to additional source-attribute values following, including a last set of events 912 having a final source-attribute value. Next, all of the events that are equal according to the function eventEqual within each subset of events are coalesced together to form nodes. For example, as shown in FIG. 9, the first event 914 in the first event subset 908 is compared to all of the other events in the first event subset 908 using the function eventEqual, with the events within the first subset of events 908 found to be equal to the first event 914 marked in FIG. 9 with checkmarks, such as checkmark 916. The first event and all other events in the first subset of events that are equal according to function eventEqual are then grouped together to form a first node 918. This process continues by selecting the first event 920 in the first subset of events 908 not equal to the previously selected event and finding all remaining events in the first subset of events equal to event 920 and grouping these events together to form a second node 922. Coalescing equal events within each subset of events together to form nodes then results in a final list of nodes 924. In the final list of nodes, events that are identical to one another within each node are collapsed into a single event. Thus, the final list of nodes 924 is shown, in FIG. 9, to be shorter than the initial set of events 904.

The method illustrated in FIG. 9 is but one of many different possible implementations of the event-to-node coalescing operation. For example, in certain cases, an eventEqual function that produces a strict ordering of events may be developed to allow a full, one-step quick-sort-based sorting of events to produce a sorted list of events in which all of the events corresponding to a particular node are contiguous. As discussed above, the criteria by which the equality of events is determined may differ, depending on implementation, data-analysis goals, and other factors.

In a next step, all of the nodes obtained by the data-processing and data-analysis steps discussed above with reference to FIGS. 1-9 are assembled into a graph. The graph is initially densely logically interconnected, with edges between all possible pairs of nodes. Each edge is labeled with the joint probability of events within the nodes connected by the edge coinciding in occurrence. The nodes correspond to general classes, categories, or types of events, the occurrences of individual events within which are defined by the metric attribute. When the metric attribute represents time, the time values associated with events that together compose a node represents the times of occurrences of the events that together compose a node. One can view this as the times of occurrences of the class or type of events represented by the node. The joint probability of two nodes is an estimate of the probability that an event selected from the first node and an event selected from the second node have metric values, the distance between which is less than or equal to a proximity threshold. When the metric attribute represents a time value, and when the proximity threshold is relatively short, the joint probability between two nodes is an estimate of the probability that the events of a pair of events selected from the two nodes are coincident, in time.

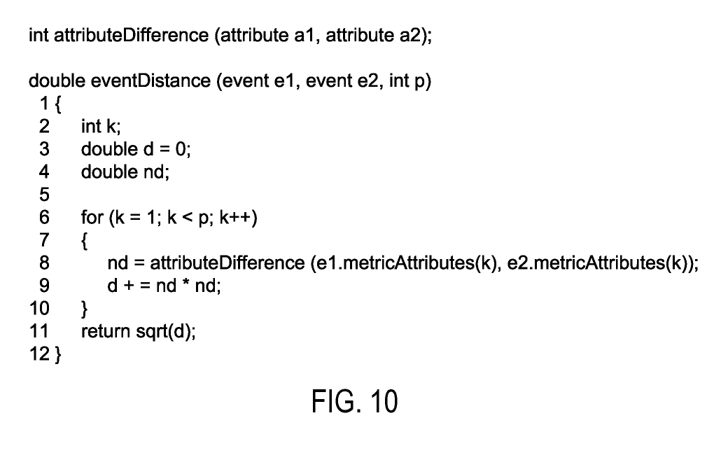

In order to assign joint probabilities to graph edges, the data-processing and data-analysis methods to which the current application is directed first compute distances between pairs of events based on the metric attributes associated with each event in the pair of events. As discussed above, there may be multiple metric attributes. In certain implementations, the multiple metric attributes may be coalesced together into a single attribute. FIG. 10 shows a C++ pseudocode function eventDistance that computes the distance between two events. The implementation of the function eventDistance shown in FIG. 10 assumes an event member function “metricAttributes,” which either selects the k^{th} metric attribute from the set of metric attributes associated with an event or extracts a k^{th} value corresponding to a k^{th} original attribute from a coalesced metric attribute, and assumes a function “attributeDifference,” which computes a numeric difference between two attribute values. The function attributeDifference computes the arithmetic difference between numerically valued attributes. The function attributeDifference may carry out more complex calculations to compute a difference between non-numerically valued attributes. As one example, the function attributeDifference may compute the difference in index or position of two symbolic attribute values within an ordering of symbolic attribute values for a particular attribute.

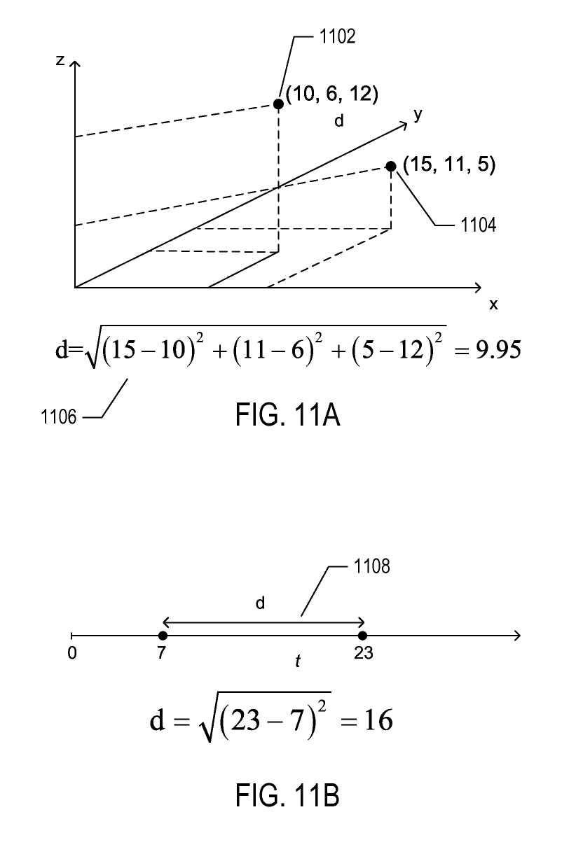

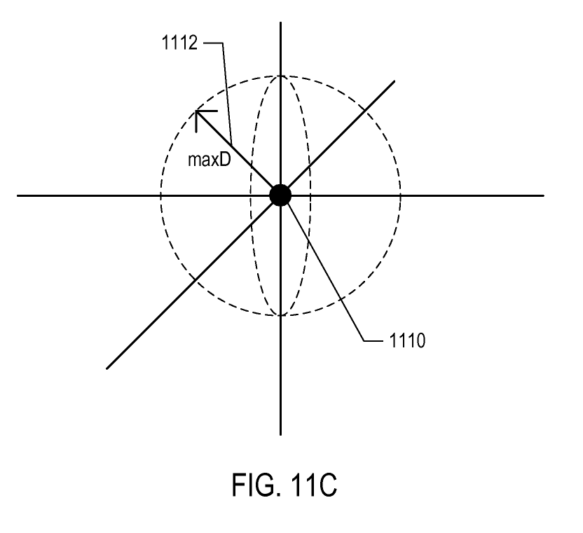

FIGS. 11A-B illustrate distances computed by the function eventDistance for two different types of attributes. In FIG. 11A, the metric attribute specifies the three-dimensional Cartesian coordinates for locations in Cartesian space 1102 and 1104, and the distance d computed by the function eventDistance is the linear distance between the two points obtained by the well-known distance formula 1106. In the case that the metric attribute is a time value, as shown in FIG. 11B, the distance computed by the function event distance is simply the absolute value of the distance between two points in time 1108. In general, two events are considered to be coincident when the distance computed by the function eventDistance for the two events is less than or equal to some proximity threshold maxD. FIG. 11C illustrates coincidence of two events. Given a metric attribute corresponding to point 1110 in FIG. 11C, for a first event, a second event is considered coincident with the first event when the distance d returned by the function eventDistance for the two events is less than or equal to the proximity threshold maxD 1112. In other words, when the location specified by the metric attribute for the second event falls within a neighbourhood of the first location 1110 with radius maxD, the two events are coincident. Note that the number of metric attributes or number of components within a metric attribute may vary from 1 to 3 or more, so that the neighbourhood specified by the proximity threshold maxD may represent a line segment, an area, a three-dimensional volume, or a higher-dimensional volume. In certain implementations, the neighbourhood may not be spherically symmetric, in which case multiple proximity thresholds may define the neighbourhood with respect to multiple dimensions. Different implementations of the function eventDistance may compute different topological distances based on different types of metrics, such as a city-block distance for locations specified by grid points.

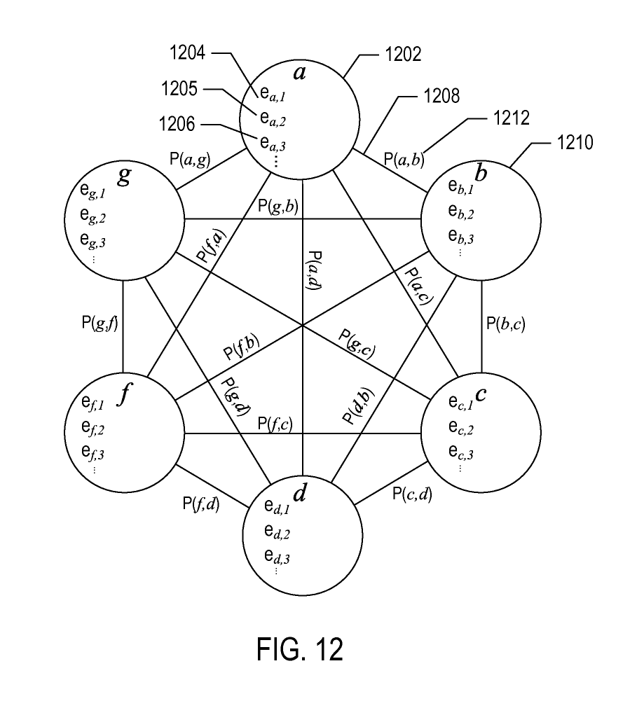

FIG. 12 illustrates an initial, densely interconnected graph of nodes. The example graph shown in FIG. 12 is trivially simple, including only six nodes. In an actual structured-data analysis, there may be hundreds, thousands, hundreds of thousands, or more nodes, each composed of tens, hundreds, thousands, or more events. In FIG. 12, each node is represented by a disk, such as disk 1202 representing a node labeled “a.” Each node is composed of multiple events, such as events e_{a,1}, e_{a,2}, e_{a,3}, . . . 1204-1206 in node a. In the initial graph, each node is connected with all other nodes by edges, such as edge 1208 interconnecting node a 1202 and node b 1210. The edges are labeled with joint probabilities, such as the joint probability P(a,b) 1212 that labels edge 1208. Each of these joint probabilities represents the probability that a pair of events selected from nodes a and b coincides in location, time, or in another attribute-specified space. As discussed below, the initial dense interconnection of nodes is subsequently reduced by eliminating edges with low information content. In certain implementations, the initial densely interconnected graph, such as the graph shown in FIG. 12, is not necessarily first constructed as an intermediate result. Instead, low-probability edges may not be even be initially generated and considered when they can be recognized as being low-probability edges prior to generation. FIG. 12 therefore shows a logical intermediate result that may or may not be generated by a particular implementation of the data-processing and data-analysis methods to which the current application is directed.

Given that there are N nodes produced by the data-processing and data-analysis methods discussed above with reference to FIGS. 1-9, and given that a pair of nodes i and j can be represented as:

node i=nᵢ={e_{i,1},e_{i,2},e_{i,3},e_{i,4}, . . . ,e_{i,u}}

node j=nⱼ={e_{j,},e_{j,2},e_{j,3},e_{j,4}, . . . ,e_{j,v}}

where e_{i,1} is the first event in node i,

the cross product of the two nodes nᵢ×nⱼ is defined to be the set of pairs of events:

$$( \begin{matrix}\{ {e}_{i , 1} , {e}_{j , 1} \} & … & \{ {e}_{i , 1} , {e}_{j , v} \} \\ ⋮ & ⋱ & ⋮ \\ \{ {e}_{i , u} , {e}_{j , 1} \} & … & \{ {e}_{i , u} , {e}_{j , v} \}\end{matrix} ) .$$

In other words, the cross product nᵢ×nⱼ is the set of all possible pairs of events in which one event is selected from node nᵢ and another event is selected from node nⱼ. The prior probability of the occurrence of an event in node i is computed as:

$$P ( {n}_{i} ) = \frac{\vert {n}_{i} \vert}{{\sum }_{k = 1}^{N} \vert {n}_{k} \vert} .$$

The probability that an event in node i will occur within a metric-attribute-defined neighbourhood of an event in node j, given the occurrence of an event in node j, can be estimated as:

$$P ( {n}_{i} \vert {n}_{j} ) = ( \frac{\vert \{ x , y \} \text{:} \{ x , y \} ∈ {n}_{i} \times {n}_{j} ⋀ distance ( x , y ) \leq Δ \vert}{\vert {n}_{j} \vert} )$$

where Δ is a distance, radius, or other neighborhood-defining parameter, as discussed above. Similarly, the probability that an event in node j will occur within a metric-attribute-defined neighbourhood of an event in node i, given the occurrence of an event in node i, can be estimated

$$P ( {n}_{j} \vert {n}_{i} ) = ( \frac{\vert \{ \{ x , y \} \text{:} \{ x , y \} ∈ {n}_{i} \times {n}_{j} ⋀ distance ( x , y ) \leq Δ \} \vert}{\vert {n}_{i} \vert} ) .$$

In other words, the probability of coincidence of events in nodes i and j, given the occurrence of an event in node i, is the number of pairs of events selected from nodes i and j that coincide, as defined by a neighborhood-defining parameter Δ, divided by the total number of events in node i. By the phrase “selecting a pair of events from nodes i and j,” the current discussion refers to selecting one of the events of a pair of events from node i and the other of the events from node j. Using a familiar Bayesian statistics theorem, the joint probability P(nᵢ,nⱼ), or the probability of coincidence of events selected from nodes i and j, from is computed as:

$$\begin{matrix}P ( {n}_{i} , {n}_{j} ) = P ( {n}_{i} \vert {n}_{j} ) P ( {n}_{j} ) \\ = ( \frac{\vert \{ \begin{matrix}\{ x , y \} \text{:} \{ x , y \} ∈ {n}_{i} \times \\ {n}_{j} ⋀ distance ( x , y ) \leq Δ\end{matrix} \} \vert}{\vert {n}_{j} \vert} ) ( \frac{\vert {n}_{j} \vert}{{\sum }_{k = 1}^{N} \vert {n}_{k} \vert} ) \\ = P ( {n}_{j} \vert {n}_{i} ) P ( {n}_{i} ) \\ = ( \frac{\vert \{ \begin{matrix}\{ x , y \} \text{:} \{ x , y \} ∈ {n}_{i} \times \\ {n}_{j} ⋀ distance ( x , y ) \leq Δ\end{matrix} \} \vert}{\vert {n}_{i} \vert} ) ( \frac{\vert {n}_{i} \vert}{{\sum }_{k = 1}^{N} \vert {n}_{k} \vert} ) ..\end{matrix}$$

In certain cases, such as when the metric attribute represents a time value, the joint and conditional probabilities may be alternatively estimated as follows:

$$\vec{P} ( {n}_{i} , {n}_{j} ) = \frac{\vert \{ \begin{matrix}\{ x , y \} \text{:} \{ x , y \} ∈ {n}_{i} ∈ \\ {n}_{j} ⋀ distance ( x , y ) \leq Δ\end{matrix} \} ⋀ x -> y \vert}{{\sum }_{k = 1}^{N} \vert {n}_{k} \vert} , \\ \overleftarrow{P} ( {n}_{i} , {n}_{j} ) = \frac{\vert \{ \begin{matrix}\{ x , y \} \text{:} \{ x , y \} ∈ {n}_{i} \times \\ {n}_{j} ⋀ distance ( x , y ) \leq Δ\end{matrix} \} ⋀ x ← y \vert}{{\sum }_{k = 1}^{N} \vert {n}_{k} \vert} , \\ \vec{P} ( {n}_{i} , {n}_{j} ) + \overleftarrow{P} ( {n}_{i} , {n}_{j} ) = P ( {n}_{i} , {n}_{j} ) .$$

In this alternative joint conditional probability estimation, the notation “nᵢ→nⱼ” means that an event selected from node i occurs, in time, prior to an event selected from node j even though the two events coincide or are coincident in time by virtue of occurring within a period of time less than the proximity threshold Δ, and the notation “nᵢ←nⱼ” means that an event selected from node j occurs, in time, prior to an event selected from node i even though the two events coincide or are coincident in time by virtue of occurring within a period of time less than the proximity threshold Δ. In other words, in the alternative computation, even though two events are deemed to be coincident in time, the ordering of the two events in time is still considered to be significant, however close in time they occur.

The mutual information between two nodes i and j can be estimated as:

$$I ( {n}_{i} , {n}_{j} ) = log \frac{P ( {n}_{i} , {n}_{j} )}{P ( {n}_{i} ) P ( {n}_{j} )} .$$

The mutual information between the two nodes i and j, I(nᵢ,nⱼ), may be a positive value or a negative value, depending on the relative magnitudes of P(nᵢ,nⱼ) and P(nᵢ)P(nⱼ). When the magnitude of the calculated mutual information between two nodes is large, there is generally a strong positive or negative correlation between occurrences of events in the two nodes. For example, a large positive mutual-information value indicates that events of two nodes coincide more frequently than would be expected based alone on the prior probabilities of the events and a large negative mutual-information value indicates that events of the two node coincide less frequently than would be expected from the prior probabilities of the events. By contrast, a mutual-information value of 0 indicates that the probability of coincidence of two events selected from the two nodes i and j is exactly the probability that would be expected given the prior probabilities of occurrences of the two events, and that, therefore, there appears to be no correlation between events of the two nodes. In the data-processing and data-analysis methods to which the current application is directed, removal of edges between pairs of nodes with low-magnitude computed mutual information provides a useful and convenient filter for removing a large amount of uninteresting information that would otherwise clutter and obscure the types of patterns and characteristics that are sought as results of the data processing and data analysis.

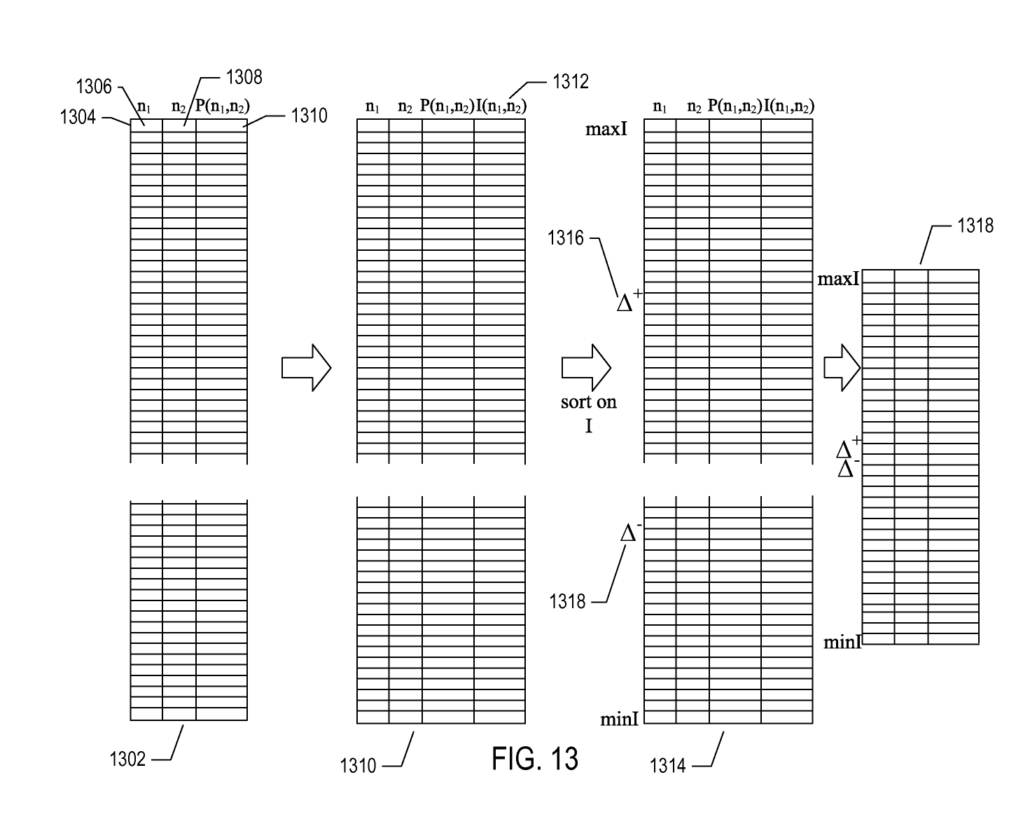

FIG. 13 illustrates graph-edge reduction based on computed mutual information between pairs of nodes. A first table 1302 shown on the left-hand side of FIG. 13 represents an initial graph, such as the densely interconnected graph shown in FIG. 12 and discussed above with reference to FIG. 12. The graph can be computationally represented as a list of edges along with the previously generated list of nodes. In FIG. 13, each row of list 1302 represents an edge within an initial graph, such as the first row 1304. Each edge is characterized by indications of the two nodes connected by the edge 1306 and 1308 as well as the computed joint probability between the two nodes P(nᵢ,n₂) 1310. The column headings n₁, n₂, and P(n₁, n₂) in FIG. 13 indicate that the columns represent the above-mentioned node and probability fields in each row of the list. In one method for edge reduction, the mutual information for each edge, discussed above, is computed, as represented in FIG. 13 by list 1310 which additionally includes computed mutual information 1312 for each edge. Then, the list of edges is sorted on the mutual-information field to produce a sorted list of edges 1314. An upper threshold mutual-information value Δ⁺ 1316 and a lower mutual-information threshold Δ1318 are next computed. The mutual-information thresholds represent positive and negative thresholds above which and below which, respectively, mutual-information values indicate sufficient correlation between nodes to be useful in subsequent data analysis. Edge reduction is accomplished by removing, from edge list 1314, those edges with mutual information falling between Δ⁺ and Δ⁻. The final edge-reduced list of edges 1318 is shown on the right-hand side of FIG. 13. In one implementation, Δ⁺ and Δ⁻ are calculated by:

Δ⁺=Q_{0.25}⁺−(0.5+ε)(Q_{0.75}⁺−Q_{0.25}⁺)

Δ⁻=Q_{0.75}⁻−(0.5+ε)(Q_{0.75}⁻−Q_{0.25}⁻)

where Qₓ⁺ is the x^{th} quartile of the positive mutual-information values and Q_{y}⁻ is the y^{th} quartile of negative mutual-information values.

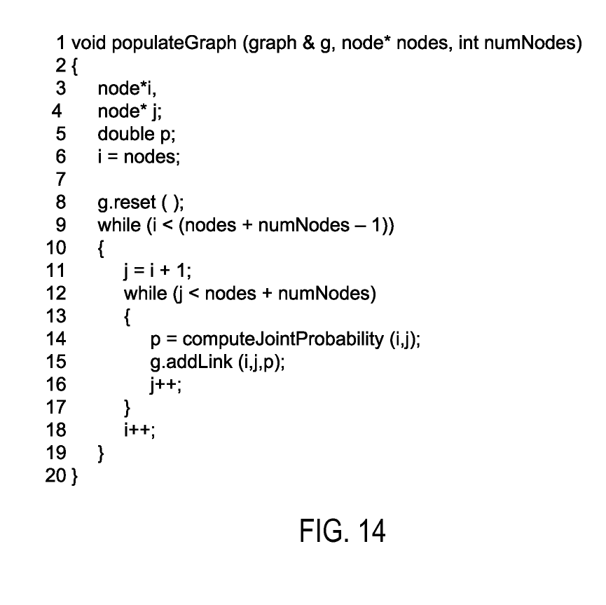

FIG. 14 shows a C++-like pseudocode example initial-graph-generation routine that can be used to generate the initial list of nodes corresponding to an initial graph, such as the graph shown in FIG. 12. In this pseudocode routine, all pairs of nodes in a provided list of nodes nodes are considered in a nested while-loop, and a link for each considered pair is added to a graph g along with a computed joint probability between the two nodes. As mentioned above, in certain implementations, construction of low-joint-probability links may be avoided.

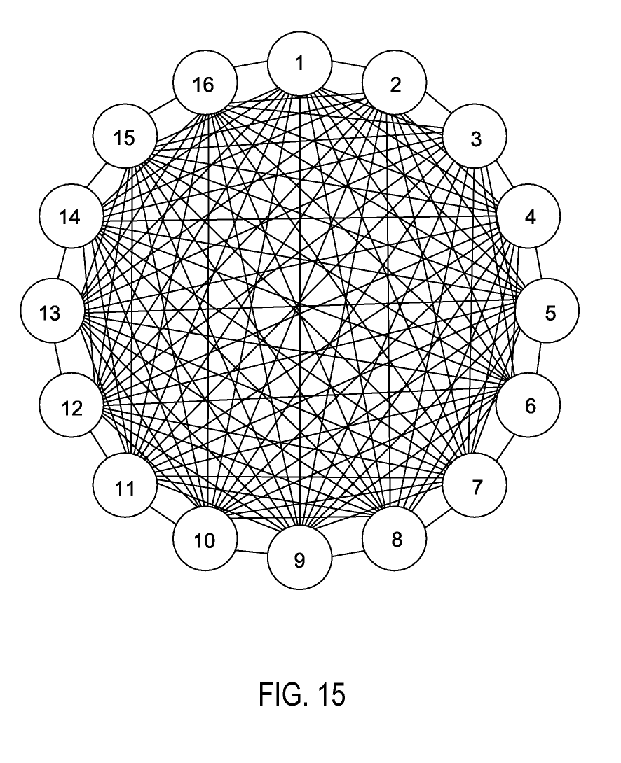

FIGS. 15-19 illustrate graph-based steps carried out in certain implementations of the data-processing and data-analysis methods to which the current application is directed. FIG. 15 shows a small, 16-node initial, densely connected node graph 1500. In FIG. 15, as in other figures referenced from the current discussion, nodes are represented by disks, such as disk 1502 that represents a node labeled “7.” Edges between nodes are shown as curved and straight lines, such as curved line 1504 that connects nodes labeled “3” 1506 and “7” 1502. As can be seen in FIG. 15, an initial fully connected graph is exceedingly complex, even for a relatively small number of nodes. Pattern recognition and data characterization would be computationally formidable without the above-discussed edge-reduction process.

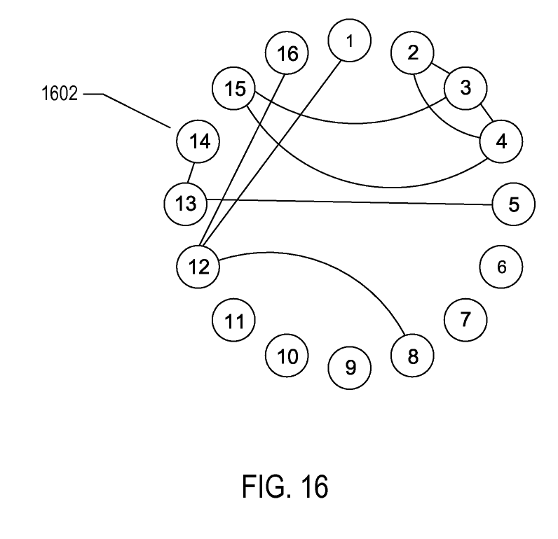

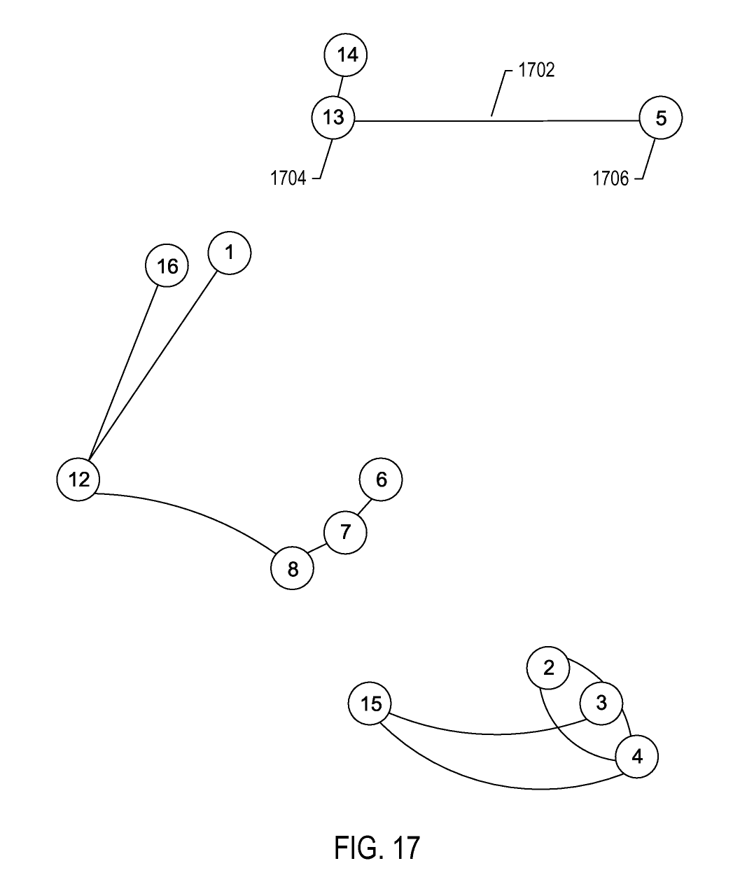

FIG. 16 shows the graph of FIG. 15 following edge reduction. As is readily apparent by comparing FIG. 15 and FIG. 16, the edge-reduced graph 1602 is far more tractable and informative than the initial fully connected graph 1500 shown in FIG. 15. In fact, the graph shown in FIG. 16 is actually three separate, mutually unconnected graphs as well as three unconnected nodes. FIG. 17 shows the edge-reduced graph shown in FIG. 16 with unconnected nodes removed and separate, unconnected graphs spatially reorganized. In general, the edge-reduction results in generation of multiple, simpler edge-reduced graphs such as those shown in FIG. 17. The number of remaining edges is controlled by the Δ⁺ and Δ⁻ thresholds, which may be varied, in certain implementations, to produce different sets of edge-reduced graphs.

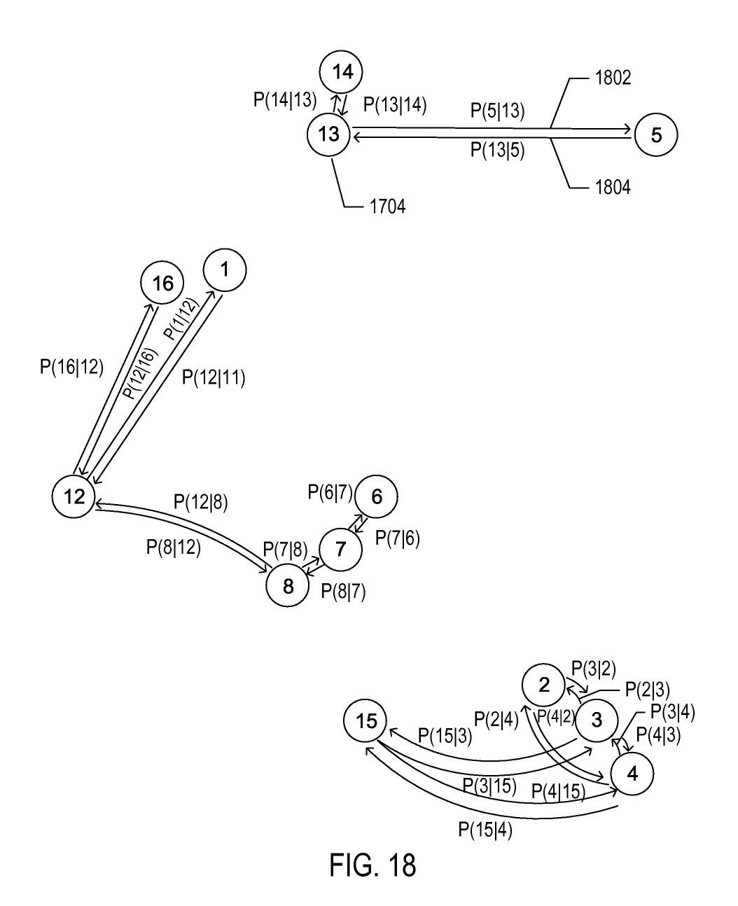

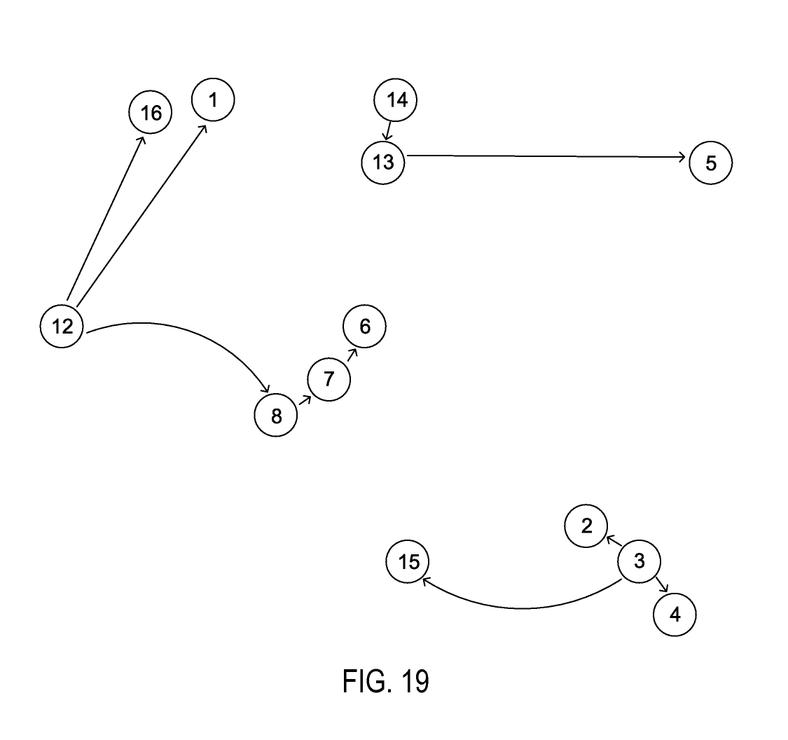

FIGS. 18-19 illustrate a next step in the data-processing and data-analysis methods to which the current application is directed. In this step, the edges in the edge-reduced graphs are assigned directions. There are many ways to assign directions to edges and, in many cases, directed edges are used only in a subset of the subsequent analytical steps. In general, the directionless joint probabilities associated with links or edges are maintained along with conditional probabilities associated with directed edges. In certain implementations, two conditional properties associated with both possible directions for a directed edge may be maintained for each pair of connected nodes in the edge-reduced graphs. In FIG. 18, each directionless edge in the edge-reduced graph shown in FIG. 17 is replaced by two directed edges, one directed edge pointing in one of two possible directions and the other directed edge pointing in the other of the two possible directions. For example, edge 1702 in FIG. 17 that interconnects the nodes labeled “13” 1704 and “5” 1706 is replaced, in FIG. 18, with directed edges 1802 and 1804, each associated with a conditional probability. Directed edge 1802, which points from node 1704 to node 1706, is associated with a conditional property P(5|13) that is an estimate of the probability of the occurrence of the event associated with node 5 given the occurrence of an event associated with node 13. Directed edge 1804 is associated with the conditional probability P(13|5) that is an estimate of the probability of coincident occurrence of an event associated with node 13 given the occurrence of an event associated with node 5. While there are many ways to assign a single directed edge for pairs of nodes connected by directional edges in the edge-reduced graphs, one method is to select the directed edge of the two different directed edges shown in FIG. 18 with greatest conditional probability. That method results in the directed edge-reduced graphs shown in FIG. 19. However, there are many other methods for selecting directed edges to produce directed graphs. As another example, when the metric corresponds to a time value, the direction of an edge may be selected as the direction with the highest corresponding directed conditional probability selected from \vec{P}(nᵢ,nⱼ) and [symbol] (nᵢ,nⱼ).

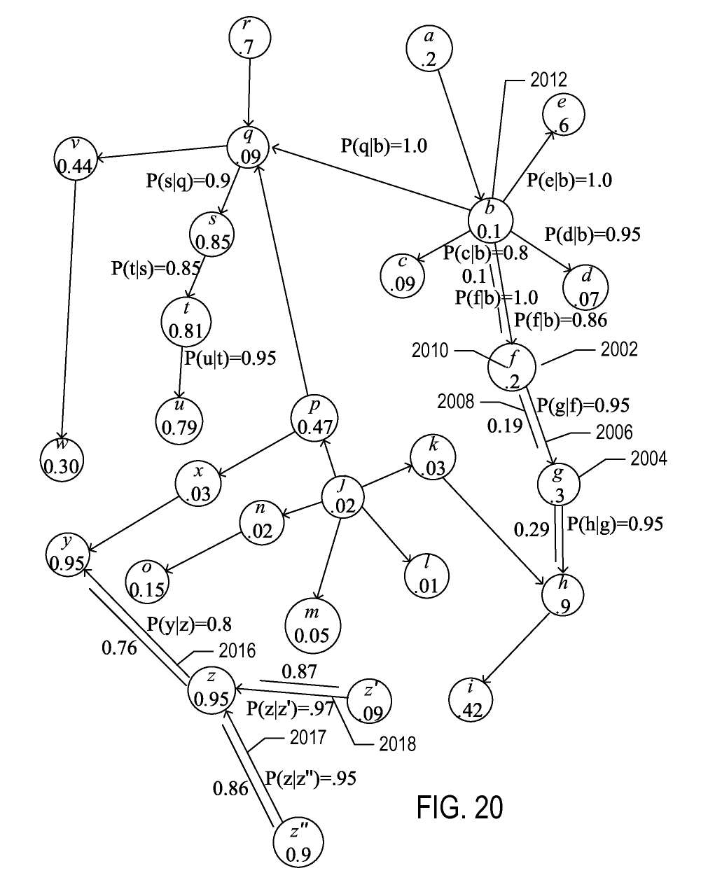

FIGS. 20-26 illustrate certain of the patterns that can be extracted from edge-reduced, directed graphs produced by the data-processing steps discussed above with reference to FIGS. 1-19. FIG. 20 shows a single, edge-reduced directed graph from which example patterns are subsequently extracted, below. In FIG. 20, 28 nodes are interconnected by directed edges. The directed edges are associated with conditional probabilities. Certain of the directed edges are also associated with directionless edges labeled with computed joint probabilities. For example, the node labeled f 2002 and the node labeled g 2004 are connected by a directed edge 2006 labeled with the conditional probability P(g|f)=0.95 and the directionless edge 2008 labeled with the direct probability P(g|j) of 0.19. In FIG. 20, each node is also labeled with a prior probability, such as the prior probability 0.2 (2010 in FIG. 20) included in the disk-like representation of the node f 2002.

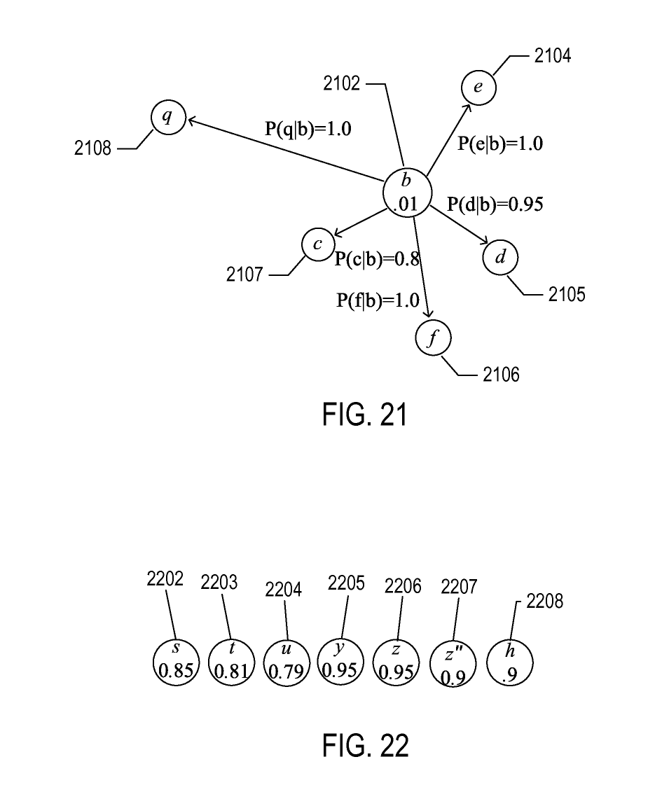

FIGS. 21-26 illustrate six different types of patterns and characteristics that can be extracted from an edge-reduced, directed graph such as that shown in FIG. 20 to provide a basis for subsequent data analysis. FIG. 21 illustrates a black-swan node. A black-swan node 2102 is a node having relatively low prior probability but having more than a threshold number of outgoing, directed edges associated with relatively high conditional probabilities. Black-swan nodes are collections of events that rarely occur but that, when they do occur, give rise to numerous other types of events. Black-swan events are useful for determining the causes of various types of events and patterns of events as well as for prediction of future events. Note that the black-swan event 2102 shown in FIG. 21, and events connected to the black-swan event by outgoing directed edges 2104-2108, have been directly extracted from the edge-reduced, directed graph shown in FIG. 20, with the black-swan event 2102 corresponding to event 2012 in FIG. 20. All of the patterns discussed with reference to FIGS. 21-26 are similarly directly extracted from FIG. 20.

FIG. 22 illustrates critical nodes. Critical nodes are nodes associated with relatively high threshold prior probabilities. All of the critical nodes 2202-2208 shown in FIG. 22 have prior probabilities greater than 0.75.

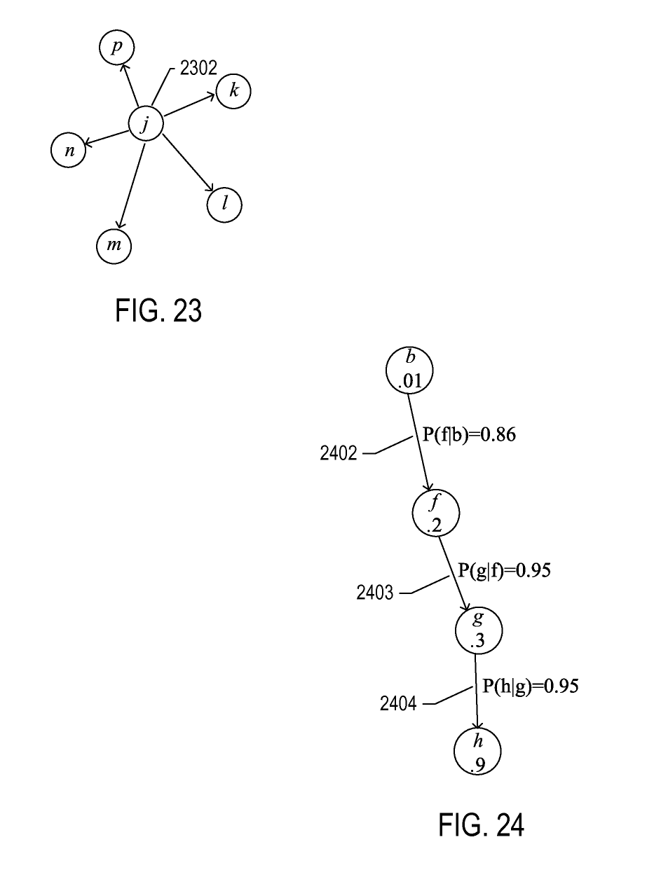

FIG. 23 illustrates a root node. A root node 2302 is a node that has only outgoing directed edges. Identification of root nodes may facilitate in diagnosing the causes of events and event patterns and may also be useful for prediction of future events.

FIG. 24 illustrates a critical path. A critical path is a set of events that can be traversed in only one way from a first event in the path to a last event in the path along directed edges. A critical path includes directed edges that are all associated with relatively high conditional probabilities. For example, in the critical path illustrated in FIG. 24, all of the directed edges 2402-2404 are associated with conditional probabilities greater than or equal to 085. Critical paths represent highly correlated events that tend to occur in sequence. Critical paths may be useful in predicting future event patterns and, like root nodes and black-swan nodes, can be used to diagnose ultimate or intermediate causes of particular events and event patterns.

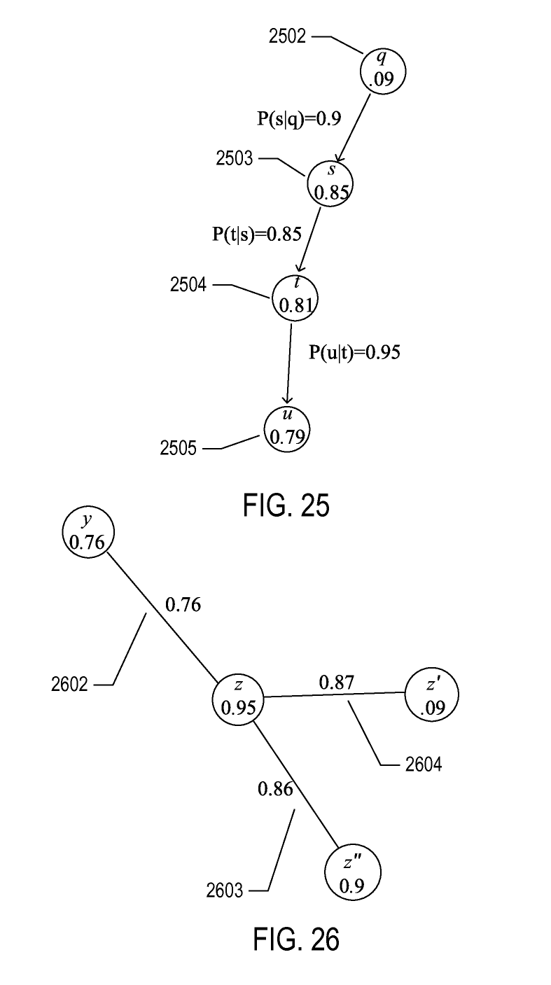

FIG. 25 illustrates an extreme path. Extreme paths are critical paths in which all of the nodes are associated with prior probabilities greater than or equal to a threshold prior probability. For example, in the extreme path shown in FIG. 25, all of the nodes 2502-2505 are associated with prior probabilities greater than 0.75. Extreme paths are critical paths that occur with high probability, and are useful in understanding systems operation, error propagation, and other such phenomena.

FIG. 26 shows a critical sector. Critical sectors are connected sub-graphs with joint probabilities associated with the connections all higher than some threshold value. In FIG. 26, the three directional edges 2602-2604 correspond to directed edges 2016-2018 in FIG. 20 and are associated with joint probabilities greater than or equal to 0.75. Critical sectors represent constellations of highly correlated events that are useful in understanding system operations, diagnostics, and prediction of future operational behaviors.

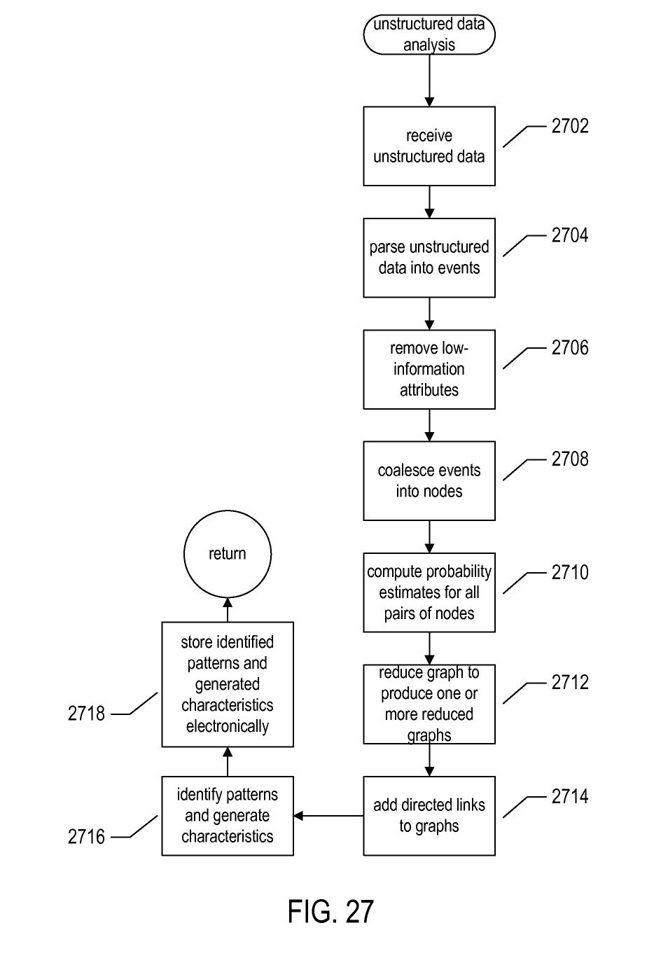

FIG. 27 provides a control-flow diagram that generally describes the unstructured-data processing and unstructured-data analysis carried out according to various implementations and methods to which the current application is directed. In step 2702, the unstructured-data analysis method receives unstructured data. As discussed above, the unstructured data may be any type of digitally encoded data stored in one or more files or other types of data objects. FIG. 1 illustrates a representation of the initially received unstructured data. Next, in step 2704, the unstructured data is parsed into a set or list of attribute-associated events. A generalized list of attribute-associated event is depicted in FIG. 3. Next, in step 2706, low-information-containing attributes are removed or filtered, in a data-reduction process discussed above with reference to FIG. 6. Next, in step 2708, the attribute-associated events are coalesced into nodes, a process discussed above with reference to FIGS. 8 and 9. In step 2710, the prior probabilities of nodes and the joint and conditional probabilities for pairs of nodes are computed and a list of node pairs is generated to represent an initial, densely interconnected graph, such as that shown in FIG. 12. Then, in step 2712, the initial, densely connected graph is edge-reduced to produce one or more edge-reduced graphs, such as that shown in FIG. 12. In step 2714, a direction is provided to directionless edges of the one or more edge-reduced graphs, as discussed above with reference to FIGS. 18 and 19. In step 2716, various patterns and characteristics are identified in, and extracted from, the one or more edge-reduced, directed graphs produced in step 2714. Examples of these patterns and characteristics are provided in FIGS. 20-26. Finally, in step 2718, the identified patterns and characteristics are electronically stored in electronic memories, data-storage devices, both memory and data-storage devices, or by other physical data-storage methods and devices to serve as a basis for subsequent analytical steps.

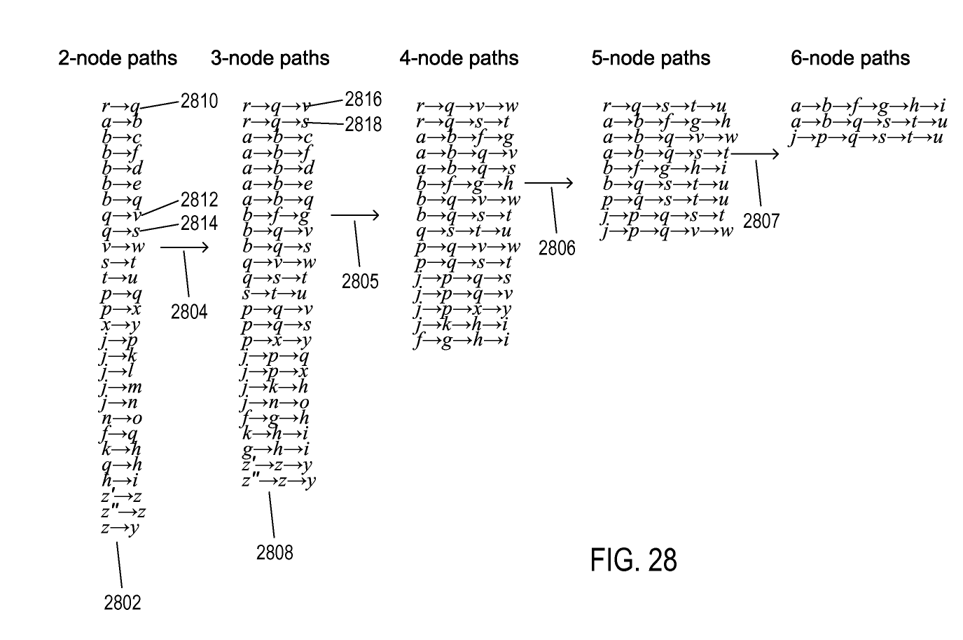

FIG. 28 illustrates construction of possible paths within an edge-reduced, directed graph such as that shown in FIG. 20. As discussed above, the graph can be fully represented, computationally, by a list of links that connect pairs of nodes within the graph. The list 2802 shown on the left-hand side of FIG. 28 includes the list of edges that occur in the edge-reduced directed graph shown in FIG. 20. This is, in fact, a list of all two-node paths within the graph. All additional paths can be discovered in iterative fashion, as shown in FIG. 28. In each iteration, represented in FIG. 28 by arrows 2804-2807, the paths with a next-largest number of nodes can be generated from the preceding, or last completed, list of paths and the list of two-node paths 2802 by combining two-node paths and paths of the last completed list of paths. A two-node path that begins with a first node equal to the final node of a path from the last completed list of paths is combined to produce a path with one more node than included in the path from the last completed list of paths. For example, in generating the list of three-node paths 2808 from the list of two-node paths 2802, each two-node path is considered, and for each considered two-node path, all of the two-node paths that begin with the node with which the currently considered two-node path ends are combined with the two-node path to generated candidate three-node paths. Those candidate three-node paths that do not contain a cycle are then selected for entry into the list of 3-node paths. For example, consider two-node path r→q 2810. In a first outer iteration of a nested iteration, the two-node path is compared to all of the remaining two-node paths in the list of two-node paths in order to identify any other remaining two-node paths that begin with the node q which can therefore be appended to the currently considered path r→q to generate a three-node path. There are two two-node paths in the remaining two-node paths 2812 and 2814 that meet this criterion, and so two-node path r→q is combined with each of these two paths to generate into three-node paths 2816 and 2818. Once the three-node paths are constructed, the four-node paths are constructed from the three-node paths by combining two-paths with three-node paths. Thus, all of the paths within a directed graph are easily identified by an iterative path-construction method starting with the list of two-node paths that is equivalent to the computation representation of the directed graph.

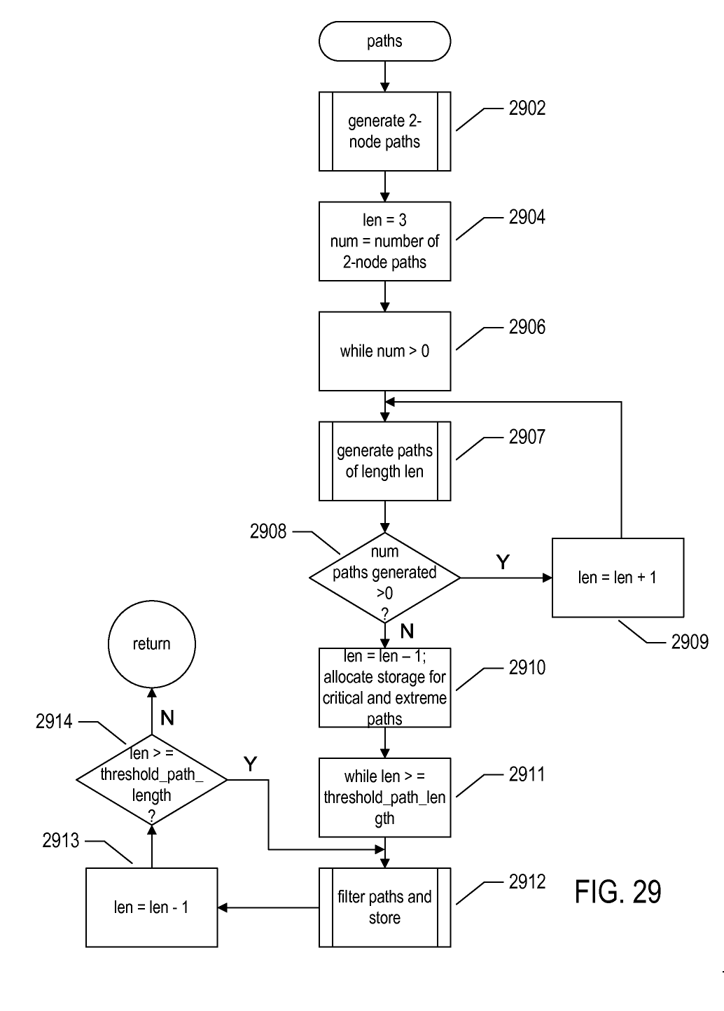

FIGS. 29-34 provide control flow diagrams that illustrate identification and extraction of certain of the various types of patterns and characteristics discussed above with reference to FIGS. 20-26. FIGS. 29-32 provide control-flow diagrams that illustrate identification and extraction of critical and extreme paths from an edge-reduced directed graph, such as that shown in FIG. 20, by a routine “paths.” In step 2902, all of the two-node paths in the edge-reduced directed graph are generated from the list of links that computationally represents the graph. Next, in step 2904, local variable len is set to 3 and local variable num is set to the number of two-node paths generated in step 2902. The variable len indicates the number of nodes in the next set of paths to be generated and the variable num is set to the number of paths in the set of current nodes. The routine “paths” generates critical and extreme paths based on the construction method illustrated in FIG. 28. In a first while-loop comprising steps 2906-2909, paths of increasing lengths are generated, via a call to the routine “generate paths of length len” in step 2907. Then, in the second while-loop of steps 2911-2914, beginning with the set of paths with the greatest number of nodes, the paths are filtered to remove shorter paths contained in longer paths.

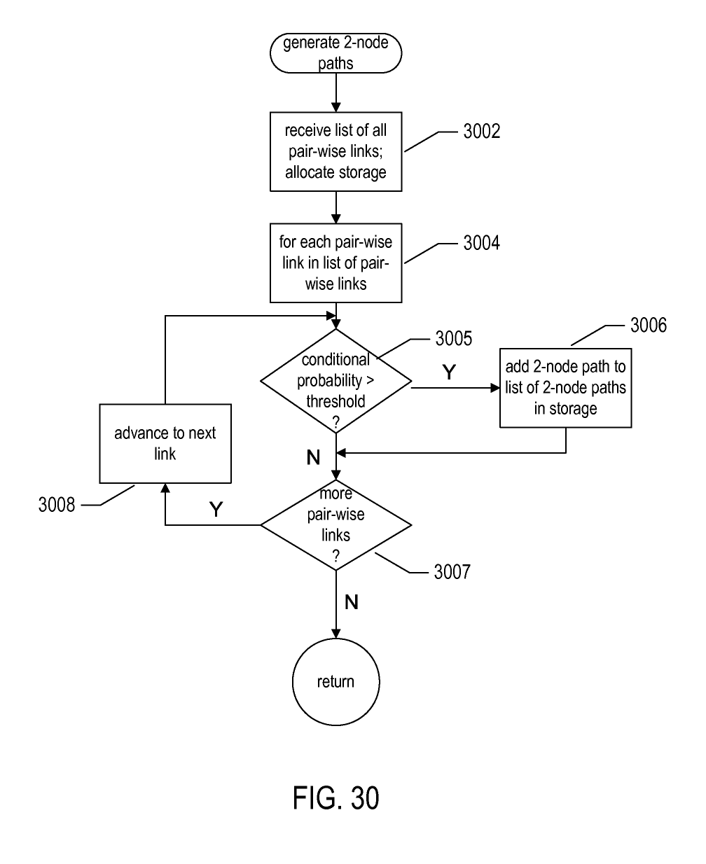

FIG. 30 provides a control-flow diagram of the routine “generate two-node paths” called in step 2902 in FIG. 29. In step 3002, the list of all pairwise links between nodes that computationally represent the directed graph is received. Then, in the for-loop of steps 3004-3008, those links associated with conditional probabilities greater than a threshold probability, as determined in step 3005, are added to the list of two-node paths in step 3006. The threshold probability employed in step 3005 is the minimum threshold probability for directed edges within a critical or extreme path.

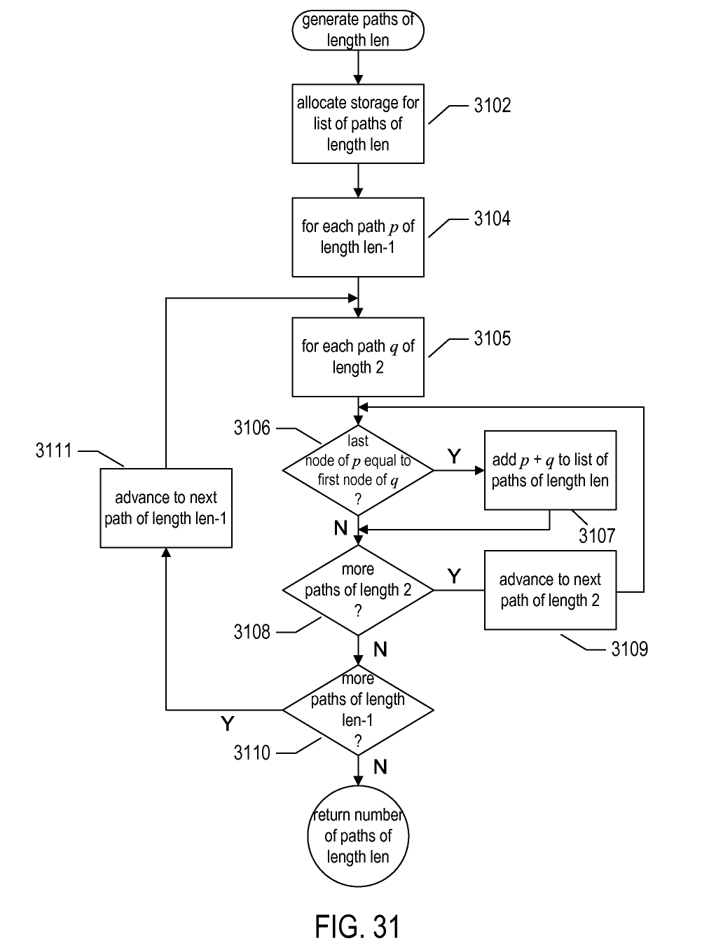

FIG. 31 provides a control-flow diagram for the routine “generate paths of length len” called in step 2907 of FIG. 29. In step 3102, storage is allocated for a list of paths of length len. Then, in the for-loop of steps 3104-3111, each path p of length len −1 generated in a previous call to routine “generate paths of length len” is considered. In the nested, inner for-loop of steps 3105-3109, each path q of length 2 selected from the list of two-node paths generated by the routine “generate two-node paths” is considered for combining to the currently considered path p to create a path of length p+1 or len. When the last node of the currently considered path p is equal to the first node of the currently considered path q and the path produced by combining paths p and q would not contain a cycle, as determined in step 3106, then the path obtained by combining path q with path p is added to the list of paths of length len in step 3107.

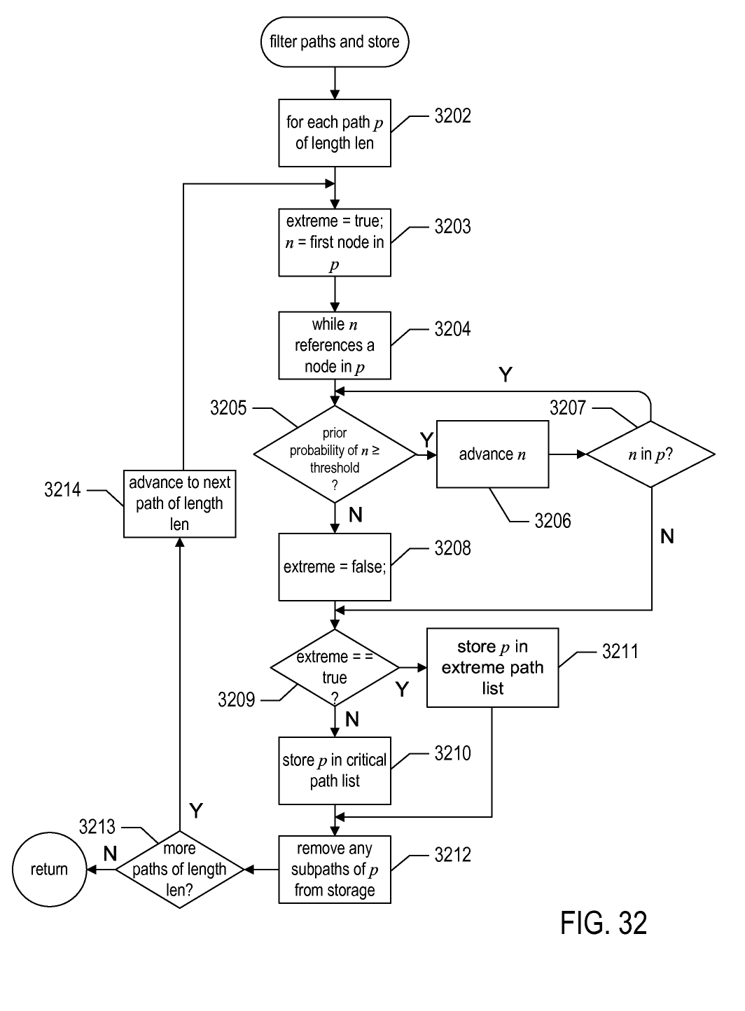

FIG. 32 provides a control-flow diagram for the routine “filter paths and store,” called in step 2912 of FIG. 29. In the outer for-loop of steps 3202-3214, each path p of length len in a set of paths of length len generated previously by the routine “generate paths of length len” is considered. In step 3203, local variable extreme is set to the Boolean value true and local variable n is set to reference a first node in path p. Then, in the while-loop of steps 3204-3208, all of the prior probabilities associated with nodes in path p are considered. When any of the nodes has a prior probability of less than a threshold value, as determined in step 3205, local variable extreme is set to false, in step 3208, and the while-loop is terminated. When, after execution of the while-loop of steps 3204-3208, the local variable extreme is true, as determined in step 3209, then path p is stored in the extreme-path list or computationally indicated to be an extreme path, in step 3211. Otherwise, path p is stored in the critical path list or computationally marked as a critical path in step 3210. In step 3212, any subpaths of path p that are found in the sets of paths with lengths less than the length of path p are removed.

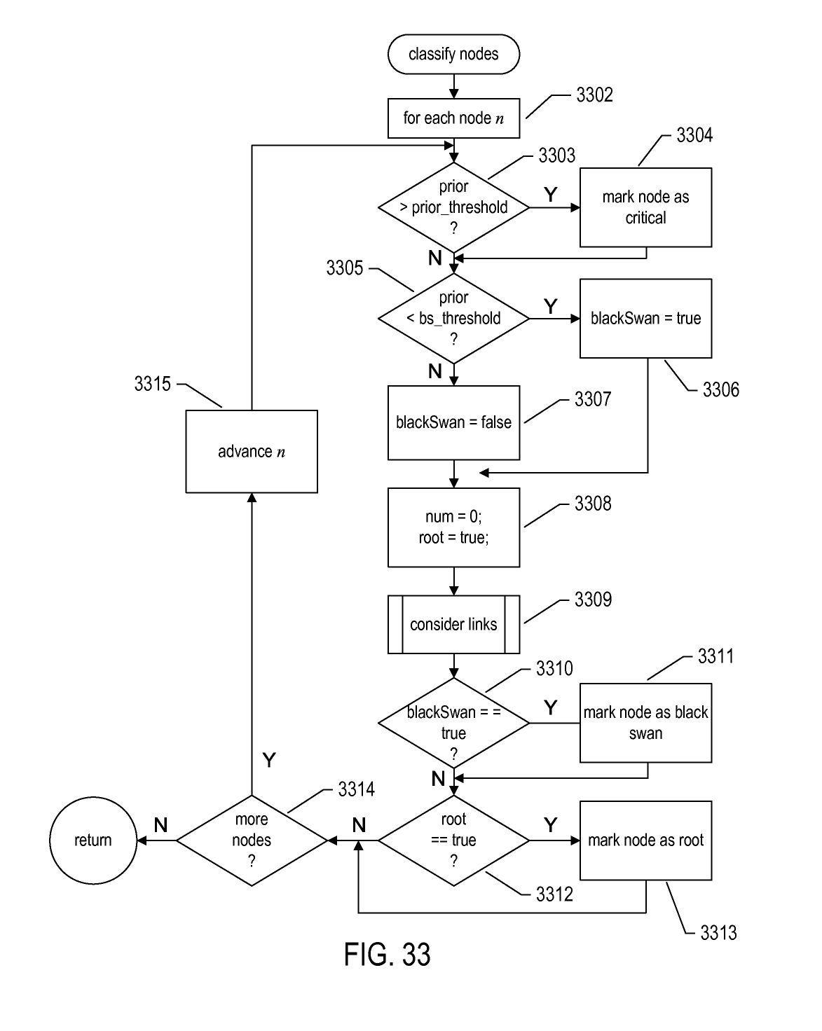

FIG. 33 provides a control-flow diagram for a routine “classify nodes” which identifies critical nodes, black-swan nodes, and root nodes. In the for-loop of steps 3302-3315, each node in a directed graph is considered. If a node has a prior probability greater than a prior-probability threshold, as determined in step 3303, the node is marked as being critical, in step 3304. When the node has a prior probability less than a black-swan threshold, as determined in step 3305, the local variable “blackSwan” is set to true, in step 3306. Otherwise, the local variable “blackSwan” is set to false, in step 3307. Next, in step 3308, local variable num is assigned to be 0 and the local variable root is set to be true. Then, in step 3309, the routine “considerLinks” is called. The routine “considerLinks” examines all of the 2-node paths that include the currently considered node to determine whether or not the currently considered node is a root node and/or a black-swan node. When the local variable “blackSwan” is true, as determined in step 3310, after execution of the routine “considerLinks,” then the node is marked as a black-swan node in step 3311. When the local variable root is still true, as determined in step 3312, following execution of the routine “considerLinks,” then the currently considered node is marked as a root node in step 3313.

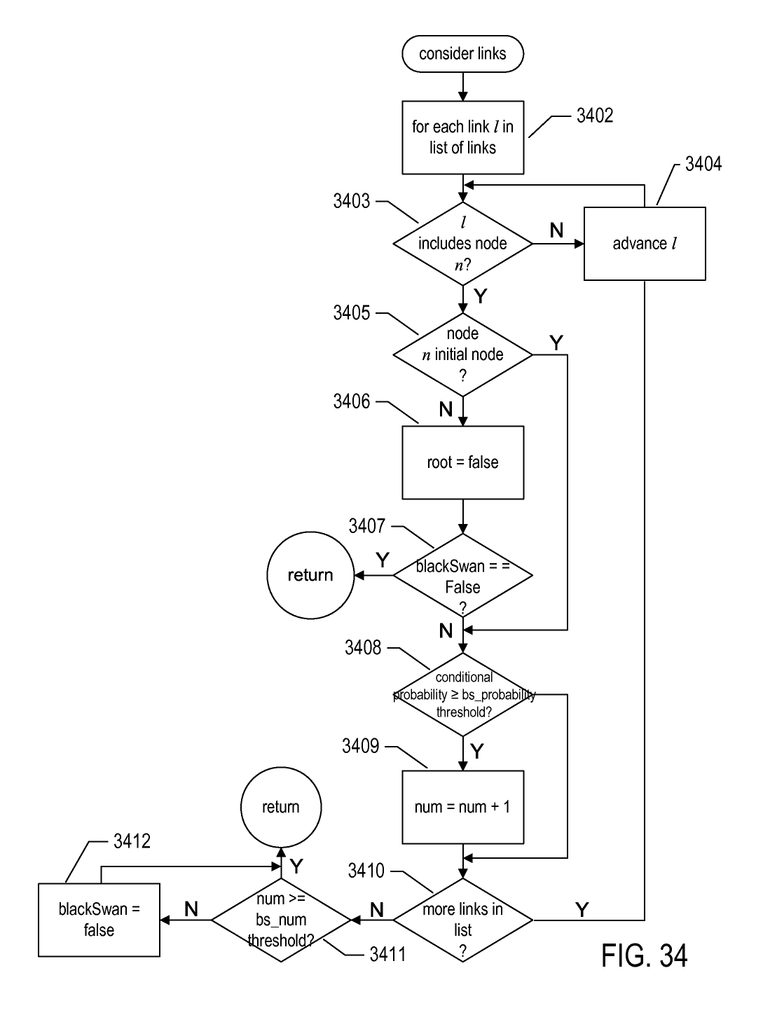

FIG. 34 provides a control-flow diagram for the routine “considerLinks,” called in step 3309 of FIG. 33. In the for-loop of steps 3402-3410, each link 1 in the list of links that computationally define the directed graph is examined. If the currently considered link 1 includes the node referenced by the reference variable n, as determined in step 3403, then the currently considered link 1 is further analyzed. Otherwise, 1 is advanced in step 3404 for another iteration of the for-loop of steps 3402-3410. When the currently considered link 1 does include the node referenced by variable n, as determined in step 3403, then, in step 3405, the routine “considerLinks” determines whether or not the node referenced by node-reference n is the initial node of the link. If not, then the local variable root is set to false, in step 3406. When the variable blackSwan is also false, as determined in step 3407, then the routine “considerLinks” returns. Otherwise, in step 3408, the routine “considerLinks” determines whether the conditional probability associated with the currently considered link 1 is greater than or equal to a threshold black-swan probability. When the conditional probability is greater than or equal to the threshold, a variable num is incremented, in step 3409. When all of the links have been considered in the for-loop of steps 3402-3410, and when the value stored in variable num is less than a black-swan threshold, as determined in step 3411, then the variable “blackSwan” is set to false, in step 3412. In alternative implementations of the above-discussed routines, various short cuts may be implemented to avoid full nested-loop iteration.

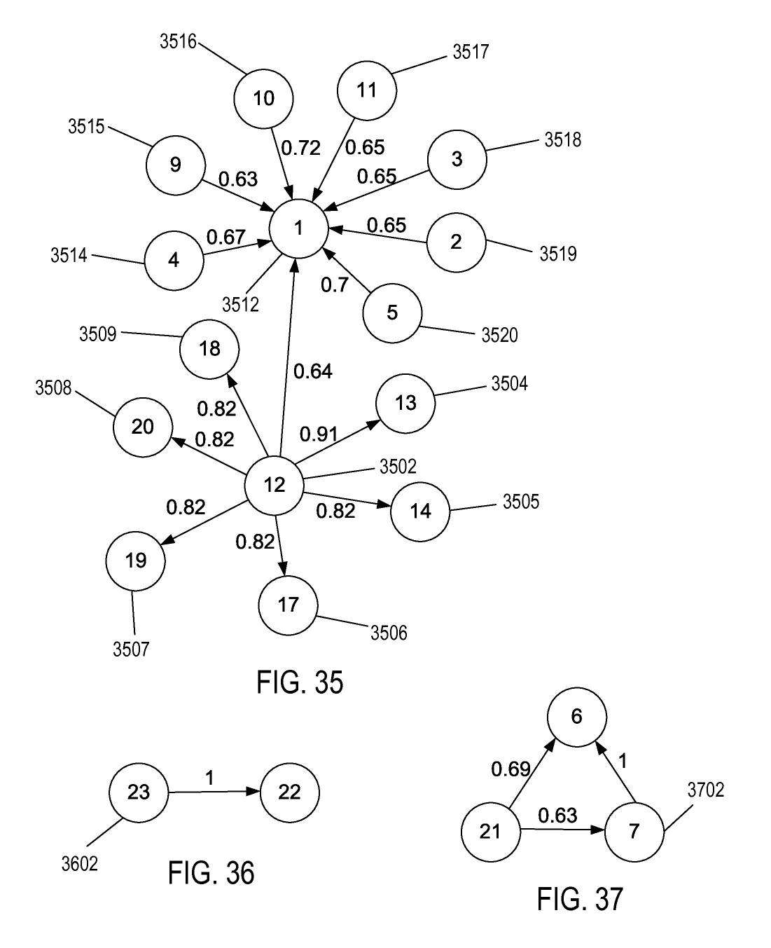

An implementation of the data-processing and data-analysis methods to which the current application is directed was used to analyze a diagnostic dump, or VPX_EVENT file, containing 610,000 events logged by a computer system. FIGS. 35-37 show certain of the patterns extracted from edge-reduced directed graphs prepared from an unstructured-data VPX_EVENT file by an implementation of the data-processing and data-analysis methods to which the current application is directed. FIG. 35, for example, shows an event 3502 having the characteristics of a black-swan event. Event 3502 is an error event that tends to generate a series of warning events 3504-3509 with relatively high probability. By contrast, event 3512 appears to be generated with moderate probability from each of a series of preceding events 3514-3520. The data-processing and data-analysis methods have uncovered events, such as event 3602 in FIG. 36 and event 3702 in FIG. 37, that always precede another event.

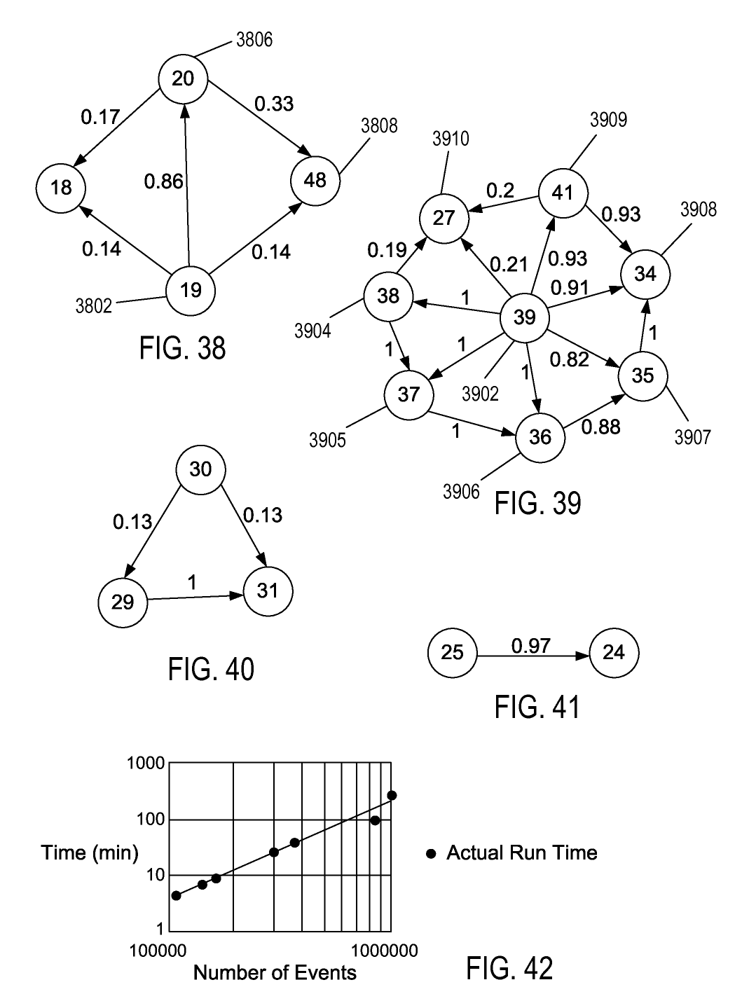

In another application of the data-processing and data-analysis methods to which the current application is directed, a data analysis was conducted on unstructured data contained both in a VPX_EVENT file as well as in files containing task data describing tasks performed by a computer system. The total unstructured data included over 370,000 events and 16,000 tasks. FIGS. 38-41 show certain of the patterns extracted from edge-reduced directed graphs prepared from the unstructured data by application of the data-processing and data-analysis methods to which the current application is directed. In FIG. 38, an extracted pattern reveals that execution of task 3802 generally leads to generation of event 3806. When event 3806 is generated, event 3808 is subsequently generated about one-third of the time. These types of interrelationships may be useful, as one example, in diagnosing occurrence of events 3808. FIG. 39 shows execution of task 3902 precedes execution of numerous other tasks 3904-3909, with high probability, and leads to generation of warning event 3910 with a normalized probability greater than 0.5.

FIG. 42 provides a graph of execution time for an implementation of the data-processing and data-analysis methods to which the current application is directed versus the number of events parsed from the unstructured data. As can be seen in FIG. 42, the plot is linear and can be expressed mathematically as:

t=cE^{1.70}

Thus, the described methods are of order 1.70 with respect to the total number of events processed. A method of order 1.70 is significantly more scalable than typical second-order algorithms, where the time of processing is expressed as:

t=cE²

For example, for an order 1.70 method that takes one minute to process 100,000 events, a million events can be processed in about 50 minutes. By contrast, a second-order method that processes 100,000 events in one minute would take 100 minutes to process a million events.

The various patterns and characteristics extracted by the data-processing and data-analysis methods to which the current application is directed are generally stored in an electronic memory or other data-storage device for subsequent higher-level analyses, including both automated and manual analyses. Thus, for example, knowledge that there is a particular critical path leading from a first event to a subsequent event of high interest, such as a hard-to-diagnose error condition, can lead to further investigation of the first event, which may ultimately lead to a root event or black-swan event close to the source of a chain of events and occurrences that lead to the hard-to-diagnose event. In a huge event log, such event sequences and interrelationships are impossible to discover manually. However, armed with patterns and characteristics extracted from the unstructured data by the data-processing and data-analysis methods described above, a human analyst may be able to directly uncover root causes of particular hard-to-diagnose errors or may at least be able to apply additional automated analytical steps to uncover potential candidate causes and sources of the hard-to-diagnose error. The data-processing and data-analysis methods, discussed above, thus provide human analysis and higher-level data-analysis programs with a method to uncover interesting and useful paths and events obscured by an enormous forest of unstructured data, and thus make tractable otherwise intractable unstructured-data analysis problems.

While the data-processing and data-analysis methods to which the current application is directed have been described as being applied to event-log files which contain historical computer-operation data, the results of the data-processing and data-analysis methods applied to historical computer-operation data can be used for real-time analysis and future-event and future-operational-characteristics prediction. As one example, recently occurring real-time events can be mapped to sub-graphs extracted from historical data each containing one or more of an identified black-swan node, an identified critical node, an identified root node, an identified critical path, an identified extreme path, and an identified critical sector. When more than a threshold number of recently occurring real-time events can be mapped to a historical sub-graph containing one or more of identified patterns and characteristics, then the likelihood of a recent, immediate, or near-future occurrence of a particular type or pattern of events may be sufficiently high to warrant generation of real-time alarms and warnings or automated undertaking of ameliorative procedures to forestall predictable consequences or serious downstream damage that might otherwise occur. The results of the above-described data-processing and data-analysis methods can be used in many additional types of applications, systems, and methods for characterizing unstructured data, discerning patterns in unstructured data, predicting future events and behaviors from unstructured data, and carrying out other information-acquisition and information-processing tasks.

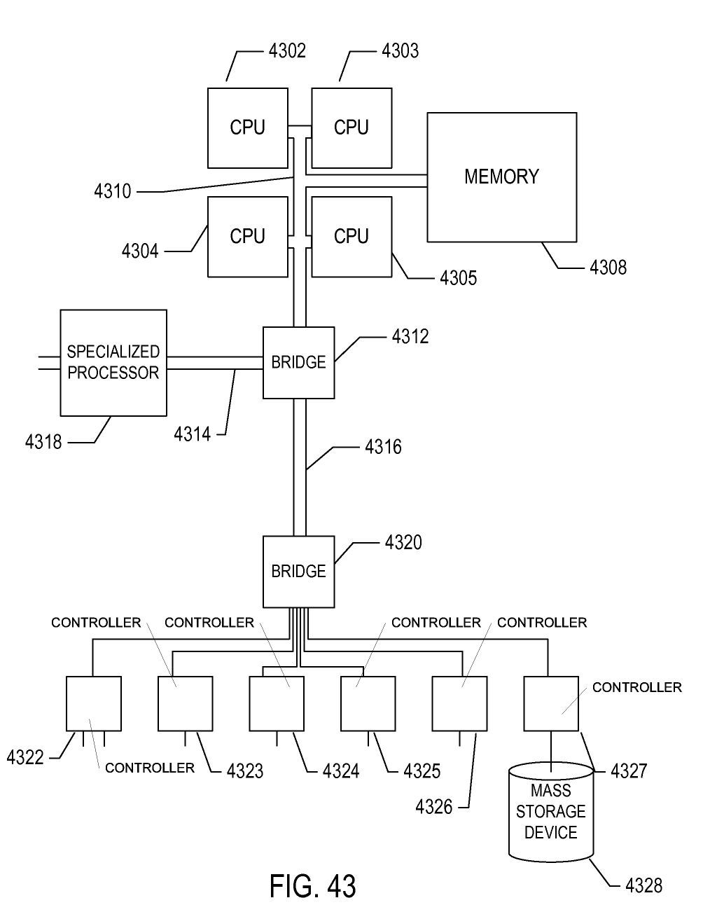

FIG. 43 illustrates a general-purpose computer system. The computer system contains one or multiple central processing units (“CPUs”) 4302-4305, one or more electronic memories 4308 interconnected with the CPUs by a CPU/memory-subsystem bus 4310 or multiple busses, a first bridge 4312 that interconnects the CPU/memory-subsystem bus 4310 with additional busses 4314 and 4316, or other types of high-speed interconnection media, including multiple, high-speed serial interconnects. These busses or serial interconnections, in turn, connect the CPUs and memory with specialized processors, such as a graphics processor 4318, and with one or more additional bridges 4320, which are interconnected with high-speed serial links or with multiple controllers 4322-4327, such as controller 4327, that provide access to various different types of mass-storage devices 4328, electronic displays, input devices, and other such components, subcomponents, and computational resources. Computers that, when executing the above-described data-processing and data-analysis methods and that therefore represent specialized data-processing and data-analysis systems to which the current application is directed may be described by the general-purpose computer architecture shown in FIG. 43, or by related architectures.

Although the present invention has been described in terms of particular embodiments, it is not intended that the invention be limited to these embodiments. Modifications within the spirit of the invention will be apparent to those skilled in the art. For example, any number of different implementations of the currently described data-processing and data-analysis methods can be obtained by varying many different design and implementation parameters, including programming language, underlying operating system, data structures, control structures, modular organization, and many other such design and implementation parameters. Many other different types of patterns and characteristics can be extracted by various different implementations of the data-processing and data-analysis methods to which the current application is directed, in addition to those described above with reference to FIGS. 21-26. In certain implementations, the types of patterns and characteristics may evolve, over time, based on feedback from human analysts and automated higher-level analytical programs. In certain implementations, the data-processing and data-analysis steps may be iteratively carried out, with different values for the various thresholds discussed above systematically employed in various iterations, in order to optimize or obtain near-optimal pattern and characteristic extraction.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A data-analysis system comprising:
one or more processors;
an electronic memory; and
a data-analysis component that executes on the one or more processors to analyze digitally encoded unstructured data stored in one or more of the electronic memory and one or more mass-storage devices by
generating a set of attribute-associated events from the unstructured data,
carrying out a data reduction of the attribute-associated events by removing low-information-containing attributes,
coalescing similar events into nodes,
extracting patterns and characteristics from edge-reduced graphs that include the nodes, and
storing the extracted patterns and characteristics in the electronic memory.

2. The data-analysis system of claim 1 wherein the data-analysis component generates attribute-associated events from the unstructured data by:
partitioning the unstructured data into a sequence of logical entries; and
for each logical entry,
parsing the logical entry into two or more attribute values corresponding to two or more attributes associated with an event corresponding to the logical entry.

3. The data-analysis system of claim 1 wherein the data-analysis component carries out a data reduction of the attribute-associated events by:
for each attribute,
determining a number of different attribute values corresponding to the attribute associated with the events of the set of attribute-associated events; and
removing the attribute when the number of different attribute values corresponding to the attribute divided by a number of events is greater than a threshold value.

4. The data-analysis system of claim 3 wherein the data-analysis system removes an attribute by one of:
storing an indication in the electronic memory that the attribute has been removed; and
deleting the attribute values associated with the attribute from the set of attribute-associated events.

5. The data-analysis system of claim 1 wherein the data-analysis component generates attribute-associated events from the unstructured data by:
partitioning the unstructured data into a sequence of logical entries; and
for each logical entry,
parsing the logical entry into a metric attribute value, a source attribute value, and one or more remaining attribute values corresponding to one or more remaining attributes associated with an event corresponding to the logical entry.

6. The data-analysis system of claim 5 wherein the data-analysis component carries out a data reduction of the attribute-associated events by:
for each remaining attribute,
determining a number of different attribute values corresponding to the remaining attribute associated with the events of the set of attribute-associated events; and
removing the remaining attribute when the number of different attribute values corresponding to the remaining attribute divided by a number of events is greater than a threshold value.

7. The data-analysis system of claim 5 wherein the data-analysis system coalesces similar events into nodes by:
sorting the attribute-associated events by source attribute value; and
for each group of attribute-associated events have a common source attribute value, grouping attribute-associated events determined to be equal into nodes.

8. The data-analysis system of claim 5 wherein two attribute-associated events are determined to be equal when the two attribute-associated events are associated with at least one common remaining attribute and wherein a number of pairs of attribute values corresponding to attributes commonly associated with the two attribute-associated events that are equivalent divided by a number of pairs of attribute values corresponding to attributes commonly associated with the two attribute-associated events that are not equivalent is less than a threshold value.

9. The data-analysis system of claim 5 wherein the data-analysis component extracts patterns and characteristics from edge-reduced graphs that include the nodes by:
generating an initial set of edges between nodes that are each associated with probability estimates computed for the events contained in the nodes; and
reducing the initial set of edges by removing low-information edges and unconnected nodes to generate one or more edge-reduced graphs, each containing a number of nodes connected by edges.

10. The data-analysis system of claim 9 wherein the data-analysis component calculates an estimate of a prior probability for each node and an estimate of a joint probability for each of a pair of nodes connected by an edge for the nodes connected by edges of the initial set of edges.

11. The data-analysis system of claim 10 wherein a prior probability for a node i, P(nᵢ), is estimated as the sum of events contained in the node divided by the total number of events.

12. The data-analysis system of claim 10 wherein a joint probability for each of a first node i and a second node j of a pair of nodes connected by an edge, P(nᵢ, nⱼ), is estimated as the product of:
a number of pairs of events, one event of each pair of events selected from the first node and one event of each pair of events selected from the second node, that are coincident divided by a total possible number of event pairs; and
the sum of the number of events in the first and second nodes divided by a total number of events.

13. The data-analysis system of claim 12 wherein two events are coincident when the distance between the events computed from the metric attributes associated with the two events is determined to be less than a threshold value.

14. The data-analysis system of claim 9 wherein the data-analysis component, after reducing the initial set of edges by removing low-information edges and unconnected nodes to generate one or more edge-reduced graphs, assigns directions to edges within the one or more edge-reduced graphs to produce one or more directed, edge-reduced graphs.

15. The data-analysis system of claim 14 wherein each directed edge that leads from a first node i to a second node j is associated with an estimate of the conditional probability, P(nᵢ|nⱼ), that an event in the first node i coincides with an event in node j given occurrence of an event j in the second node j.

16. The data-analysis system of claim 15 wherein two events are coincident when the distance between the events computed from the metric attributes associated with the two events is determined to be less than a threshold value.

17. The data-analysis system of claim 1 wherein the data-analysis component extracts critical paths, extreme paths, critical nodes, root nodes, black-swan nodes, and critical sectors from one or more directed, edge-reduced graphs.

18. The data-analysis system of claim 17 wherein a critical node is a node n, with an estimated prior probability P(nᵢ) greater than a threshold value.

19. The data-analysis system of claim 17 wherein a root node is a node with only directed edges leading from the root node to other nodes and wherein a black-swan node is a node with an estimated prior probability P(nᵢ) less than a first threshold value and with greater than a second threshold number of outgoing edges associated with conditional probabilities greater than a third threshold value.

20. The data-analysis system of claim 17 wherein a critical path is a path of nodes joined by directed edges that can be traversed in only one way from a first node in the path to a final node in the path, each directed edge associated with a conditional probability greater than a first threshold value, and an extreme path is a critical path in which all nodes have prior probabilities greater than a second threshold value.

21. The data-analysis system of claim 17 wherein a critical sector is a connected sub-graph with edges associated with joint probabilities greater than a threshold value.

22. The data-analysis system of claim 1 further including a second data-analysis component that:
receives additional unstructured data;
retrieves the stored extracted patterns and characteristics from the electronic memory; and
using the retrieved extracted patterns and characteristics to characterize and extract additional patterns from the additional unstructured data.

23. The data-analysis system of claim 1 wherein the second data-analysis component uses the characterization and extracted additional patterns from the additional unstructured data to generate warnings, invoke ameliorative procedures, and provide predictions.

24. A method carried out within a computer system having one or more processors and an electronic memory that analyzes digitally encoded unstructured data stored in one or more of the electronic memory and one or more mass-storage devices, the method comprising:
generating a set of attribute-associated events from the unstructured data;
carrying out a data reduction of the attribute-associated events by removing low-information-containing attributes;
coalescing similar events into nodes;
extracting patterns and characteristics from edge-reduced graphs that include the nodes; and
storing the extracted patterns and characteristics in the electronic memory.

25. The method of claim 24 wherein generating a set of attribute-associated events from the unstructured data further comprises:
partitioning the unstructured data into a sequence of logical entries; and
for each logical entry,
parsing the logical entry into two or more attribute values corresponding to two or more attributes associated with an event corresponding to the logical entry.

26. The method of claim 24 wherein carrying out a data reduction of the attribute-associated events by removing low-information-containing attributes further comprises:
for each attribute,
determining a number of different attribute values corresponding to the attribute associated with the events of the set of attribute-associated events; and
removing the attribute when the number of different attribute values corresponding to the attribute divided by a number of events is greater than a threshold value.

27. The method of claim 24 wherein generating a set of attribute-associated events from the unstructured data further comprises:
partitioning the unstructured data into a sequence of logical entries; and
for each logical entry,
parsing the logical entry into a metric attribute value, a source attribute value, and one or more remaining attribute values corresponding to one or more remaining attributes associated with an event corresponding to the logical entry.

28. The method of claim 27 wherein carrying out a data reduction of the attribute-associated events by removing low-information-containing attributes further comprises:
for each remaining attribute,
determining a number of different attribute values corresponding to the remaining attribute associated with the events of the set of attribute-associated events; and
removing the remaining attribute when the number of different attribute values corresponding to the remaining attribute divided by a number of events is greater than a threshold value.

29. The method of claim 27 wherein coalescing similar events into nodes further comprises:
sorting the attribute-associated events by source attribute value; and
for each group of attribute-associated events have a common source attribute value, grouping attribute-associated events determined to be equal into nodes.

30. The method of claim 27 wherein two attribute-associated events are determined to be equal when the two attribute-associated events are associated with at least one common remaining attribute and wherein a number of pairs of attribute values corresponding to attributes commonly associated with the two attribute-associated events that are equivalent divided by a number of pairs of attribute values corresponding to attributes commonly associated with the two attribute-associated events that are not equivalent is less than a threshold value.

31. The method of claim 27 wherein the data-analysis component extracts patterns and characteristics from edge-reduced graphs that include the nodes by:
generating an initial set of edges between nodes that are each associated with probability estimates computed for the events contained in the nodes; and
reducing the initial set of edges by removing low-information edges and unconnected nodes to generate one or more edge-reduced graphs, each containing a number of nodes connected by edges.

32. The method of claim 31
wherein the data-analysis component calculates an estimate of a prior probability for each node and an estimate of a joint probability for each of a pair of nodes connected by an edge for the nodes connected by edges of the initial set of edges;
wherein a prior probability for a node i, P(nᵢ), is estimated as the sum of events contained in the node divided by the total number of events;
wherein a joint probability for each of a first node i and a second node j of a pair of nodes connected by an edge, P(nᵢ, nⱼ), is estimated as the product of
a number of pairs of events, one event of each pair of events selected from the first node and one event of each pair of events selected from the second node, that are coincident divided by a total possible number of event pairs, and
the sum of the number of events in the first and second nodes divided by a total number of events; and
wherein two events are coincident when the distance between the events computed from the metric attributes associated with the two events is determined to be less than a threshold value.

33. The method of claim 31 wherein the data-analysis component, after reducing the initial set of edges by removing low-information edges and unconnected nodes to generate one or more edge-reduced graphs, assigns directions to edges within the one or more edge-reduced graphs to produce one or more directed, edge-reduced graphs.

34. The method of claim 33
wherein each directed edge that leads from a first node i to a second node j is associated with an estimate of the conditional probability, P(nᵢ|nⱼ), that an event in the first node i coincides with an event in node j given occurrence of an event j in the second node j;
wherein two events are coincident when the distance between the events computed from the metric attributes associated with the two events is determined to be less than a threshold value; and
wherein the data-analysis component extracts critical paths, extreme paths, critical nodes, root nodes, black-swan nodes, and critical sectors from one or more directed, edge-reduced graphs.

35. The method of claim 34
wherein a critical node is a node n, with an estimated prior probability P(nᵢ) greater than a threshold value;
wherein a root node is a node with only directed edges leading from the root node to other nodes and wherein a black-swan node is a node with an estimated prior probability P(nᵢ) less than a first threshold value and with greater than a second threshold number of outgoing edges associated with conditional probabilities greater than a third threshold value;
wherein a critical path is a path of nodes joined by directed edges that can be traversed in only one way from a first node in the path to a final node in the path, each directed edge associated with a conditional probability greater than a first threshold value, and an extreme path is a critical path in which all nodes have prior probabilities greater than a second threshold value; and
wherein a critical sector is a connected sub-graph with edges associated with joint probabilities greater than a threshold value.

36. The method of claim 24 further including:
receiving additional unstructured data;
retrieving the stored extracted patterns and characteristics from the electronic memory; and
using the retrieved extracted patterns and characteristics to characterize and extract additional patterns from the additional unstructured data.

37. The method of claim 36 further including using the characterization and extracted additional patterns from the additional unstructured data to generate warnings, invoke ameliorative procedures, and provide predictions.

38. A computer-readable medium encoded with computer instructions that implement a method carried out within a computer system having one or more processors and an electronic memory that analyzes digitally encoded unstructured data stored in one or more of the electronic memory one or more mass-storage devices, the method comprising:
generating a set of attribute-associated events from the unstructured data;
carrying out a data reduction of the attribute-associated events by removing low-information-containing attributes;
coalescing similar events into nodes;
extracting patterns and characteristics from edge-reduced graphs that include the nodes; and
storing the extracted patterns and characteristics in the electronic memory.
